(19) United States
(12) Patent Application Publication
(10) Pub. No.: US 2007/0029356 A1
(43) Pub. Date: Feb. 8, 2007

(54) Baby band

(75) Inventors: Yuko Moriguchi, Saitma (JP); Yoshiko Shiraishi, Saitama (JP); Toshiro Yoshie, Tokyo (JP); Yutaka Ukitsu, Tokyo (JP)

Correspondence Address: YOUNG & THOMPSON, 745 SOUTH 23RD STREET, 2ND FLOOR, ARLINGTON, VA, 22202, US

(73) Assignee: Combi Corporation, Tokyo (JP)

(21) Appl. No.: 10/576,308

(22) PCT Filed: Oct. 20, 2004
(86) PCT No.: PCT/JP04/15514

§ 371 Date: Apr. 19, 2006

(30) Foreign Application Priority Data
Oct. 20, 2003 (JP) 2003-359852
Oct. 20, 2003 (JP) 2003-359863
Oct. 20, 2003 (JP) 2003-359867
Oct. 20, 2003 (JP) 2003-359878

(51) Int. Cl. A61G 1/00; A61G 5/00

(52) U.S. Cl. 224/160; 224/158

(57) ABSTRACT

A baby band, comprising a baby band body (2) installed on a user (201) and a seat (3) for lateral holding suspended from the baby band body (2) to hold an infant (200) in a laterally held state. The seat (3) for lateral holding comprises a seat body (40) with a head support part (42a) and a hanging board (41) disposed to laterally cross the head support part (42a) and having a rigidity given by a core material (57) formed of a hard material. The lateral both sides of the head support part (42a) are suspended from the baby band body (2) and supported through the hanging board (41).

### TECHNICAL FIELD

The present invention relates to an infant carrier for carrying an infant in a desired state such as a vertically-carrying state, a back-carrying state or a horizontally-carrying state by assembling an infant carrier main body and an attachment such as a vertically-carrying seat or a horizontally-carrying seat, joining structure, and a fixed side buckle to use therefore.

### BACKGROUND ART

It is known an infant carrier in which an infant carrier main body, which a user put on with his/her chest or back with touching it, is formed in a bag-like shape, and an infant is accommodated in the bag-like portion so that the infant can be carried in the vertically-carrying or the back-carrying state (for example, with reference to Japanese Patent Application Laid-Open (JP-A) No. 2000-245581 or JP-A 2002-282097). In the infant carrier described in these references, a pair of arms is made to be projected from both sides of a head supporting portion of a horizontally-carrying seat (a head keeping for babies), and these arms are made to be hung on a shoulder belt portion of the infant carrier main body which the user put on, thereby the horizontally-carrying seat is suspended and supported.

Further, in the infant carrier described above, the infant carrier main body is provided with a back touching portion and a crotch touching portion for supporting a back or a crotch of the infant. An adjusting fastener is provided therebetween, and by fastening or unfastening the adjusting fastener, the length of the lower part of the infant carrier main body is changed, thereby the depth of the crotch touching portion is changed depending on a physique of the infant.

Further, in the infant carrier described above, a pair of male and female buckles is used as means for joining such as the shoulder belt of the infant carrier to the fixed portion of the others.

### DISCLOSURE OF THE INVENTION

The Problem to be Solved

The prior infant carrier described above has following problems.

In the prior infant carrier, because a load, generated when the horizontally-carrying seat is hung, acts on the both sides of the head supporting portion through the pair of arms, therefore, the both sides of the head supporting portion are lifted compared to the middle portion. Consequently, the space around the infant head is made to be narrow, and the comfortableness is sometimes spoiled.

The prior infant carrier main body is a sewn products, and nothing but a soft material such as a cushioning material is packed inside. Therefore, even if the infant carrier main body is fixed to around both of the shoulder and the waist of the user, the infant carrier main body is deformed by a load generated when it is used, as a result, the load concentrates on the shoulder of the user, thus the load can not be dispersed around the waist sufficiently.

In the prior infant carrier, the infant carrier main body itself is formed as bag-like, however in this case, the shape of the infant carrier main body is complicated, and the supporting form of an infant cannot be changed flexibly. Therefore, an infant carrier is considered in which by mounting a vertically-carrying seat formed as a part separated from an infant carrier main body on the infant carrier main body, a bag-like portion for accommodating an infant vertically is formed between the infant carrier main body and the vertically-carrying seat. In this case, it is desirable to make a depth of a bottom portion of the bag-like portion adjustable as same as the prior infant carrier.

In general, when the same infant carrier main body is used in both vertical-carrying state and back-carrying state, how to the user put on the infant carrier main body is different depending on the carrying state of the infant. For example, when the infant is carried in the vertically-front-carrying state, the infant carrier main body is made to be touched to the chest of the user, and the shoulder belt is put on around the shoulder in a so-called crossing-hanging state, however when the infant is carried in the vertically-back-carrying state, the infant carrier main body is made to be touched to the back of the user, and the shoulder belt is put on around the shoulder in a so-called ruck-hanging state. In this way, though how to put on the infant carrier main body changes greatly depending on the direction or the position of the infant, the prior infant carrier main body does not consider such a change, thus, depending on supporting states, there is a case that the infant carrier main body is hardly to put on in a best state.

In the prior infant carrier, the infant carrier main body is formed itself in a bag-like shape, however in this case, the shape of the infant carrier main body is complicated, and the supporting state of the infant can not be changed flexibly. Therefore, an infant carrier is considered in which the various supporting pattern can be realized by mounting a horizontally-carrying seat or a vertically-carrying seat, which are formed as a part separated from the infant carrier main body, on the infant carrier main body selectively. However, when it is used in such a different pattern, there is a risk which the usability for the user turns worse or the amenity for the infant is diminished.

In the prior art, a fixed side buckle attached to a fixed portion is joined to the fixed portion by winding a buckle fixing belt around a belt through portion positioned at a back end thereof and by sewing the buckle fixing belt on the fixed portion. Therefore, as for the front end side of the fixed side buckle, that is a side to be joined to a belt-shaped article such as a shoulder belt, the fixed side buckle can be freely moved. In this case, the direction when the buckle of the belt-shaped article side is mounted is hard to be determined, and it is inconvenient because the tensile load which acts on a pair of buckles from the belt-shaped article concentrates on the fixed position of the back end side of the fixed side buckle, thus the road cannot be dispersed to the fixed portion load broadly. For example, when the shoulder belt of the infant carrier is joined to the waist touching portion using such a joining structure, the waist touching portion can not be pulled to the user's side widely by dispersing the tension of the shoulder belt to the waist touching portion, therefore the load locally acts on the user. Also, there is a risk that the fixed side buckle is joined to the belt-shaped article in an unnatural direction.

In the prior infant carrier, the horizontally-carrying seat is hung from the upper position, thus the horizontally-carrying seat is easy to swing around the hanging supporting point, and sometimes it becomes necessary for the user to restrain the swing by touching to the horizontally-carrying seat by a hand. In addition, in the case a plurality of fastenings is provided to the infant carrier main body for attaching to the other attachment such as a vertically-carrying seat, it is sometimes difficult to distinguish the appropriate fastening when the horizontally-carrying seat is attached to it. Further, in the prior infant carrier, an abdomen of the infant laid on the horizontally-carrying seat is covered with a pad, but the chest is exposed.

Means for Solving the Problem

An object of the invention is to provide an infant carrier capable of providing enough space around an infant head.

To achieve the above mentioned object, an infant carrier according to the first aspect of the present invention comprising an infant carrier comprising an infant carrier main body to be put on by a user and a horizontally-carrying seat to be suspended from the infant carrier main body to hold an infant in a horizontally-carrying state, wherein the horizontally-carrying seat comprises: a seat main body comprising a head supporting portion; and a hanging board arranged so as to cross the head supporting portion along a width direction and on which a rigidity is exerted by a core material consisting of a hard material, and through the hanging board, both sides of the width direction of the head supporting portion is hung from the infant carrier main body.

According to the infant carrier of the first aspect of the present invention, the hanging board exists between the head supporting portion of the seat main body and the infant carrier main body, and deformation of the head supporting portion is restricted because of the rigidity of the hanging board, thus when the infant is hung in the horizontally-carrying state, enough space is ensured around the head holding portion.

In the infant carrier of the first aspect of the present invention, the rigidity to be applied to the hanging board is sufficient if the deformation of the head supporting portion can be prevented so that practically enough space around the head supporting portion is ensured, and the core material of the hanging board do not need to be a complete rigid body. Even though it is a resin material comprising elasticity for example, if the elastic deformation amount is contained in the above-describe range, it is included in the scope of the hard material in the first aspect the present invention.

In the infant carrier of the first aspect of the present invention, a back board consisting of a hard material is provided in an inside of the seat main body, and the hanging board may be arranged so as to be overlapped in a bottom of the back board. According to such an aspect, reaction force of the hanging load acting on the seat main body through the hanging board can be dispersed to wide area of the seat main body, thereby the deformation of the head supporting portion can be restricted more surely and in a smaller extent.

In the infant carrier of the first aspect of the present invention, the hanging board may be detachable to the seat main body. By removing the hanging board from the seat main body, the hanging board can be changed or washed independently, thus it is convenient. In addition, when the seat main body is carried with the user, the volume of the hanging board is decreased, thereby the portability is increased.

In the infant carrier of the first aspect of the present invention, a hanging belt for hanging the hanging board to the infant carrier main body is provided at an end of the hanging board, a belt side fastening and a hook capable of engaging with the belt side fastening are provided on the hanging belt, a body side fastening through which the hanging belt can be passed is provided on the infant carrier main body, a board side fastening through which the hanging belt can be passed is provided on the other end of the hanging belt, and by engaging the hook through which the body side fastening and the board side fastening are passed successively with the belt side fastening, both ends of the hanging belt may be hung and supported from the body side fastening.

According to such an attaching structure, only providing the body side fastening through which the hook can be passed is required to the infant carrier main body, therefore it is advantageous to increase a versatility of the infant carrier main body.

In the aspect using the hanging belt, further, an attaching direction of the hanging board to the seat main body may be changeable relative to a width direction of the seat main body. In this case, when the attaching direction of the horizontally-carrying seat to the infant carrier main body is changed, by reversing the attaching direction of the hanging board so that it corresponds to the direction of the horizontally-carrying seat, the far and near relation between both sides of the hanging board and the infant carrier main body can be made to be constant regardless of the direction of the horizontally-carrying seat. Thereby, regardless of the direction of the horizontally-carrying seat, the hanging operation of the hanging board to the infant carrier main body can be conducted in a constant feeling.

The infant carrier may be constructed so that an excess length portion of the hanging belt is drawn from the hook so as to be folded back, in the state in which the hook passes through the board side fastening, the excess length portion hangs on the board side fastening, and the hook becomes incapable of passing through the board side fastening. According to this aspect, even if the hook of the hanging belt falls off from the belt side fastening, the hooking portion engages with the board side fastening, thus the releasing of the hook of the hanging belt is prevented. Therefore, the safeness is improved.

The board side fastening may be ring-like, and may be bent to project to the outside of the width direction of the seat main body seeing from the side. In this case, the projection of the board side fastening and the hanging belt hanging to them to the head supporting portion side can be restrained, thus an effect for preventing a contact to the head of the infant by such as a board side fastening can be increased.

Further, a stopper to restrain the slipping of the hanging belt from the body side fastening may be provided on the hanging belt. By providing such a stopper, the hanging state of the horizontally-carrying seat from the infant carrier main body can be further stabilized.

Another object of the present invention is to provide an infant carrier in which a burden applied to a user is relieved by dispersing a load imparted to an infant carrier main body to each portion of the user.

To achieve above described object, an infant carrier according to the second aspect of the present invention is an infant carrier in which a vertically-carrying seat constructed as a separated part from an infant carrier main body is mounted on the infant carrier main body which a user put on a chest or a back being touched, the infant is supported in a vertically-carrying state or a horizontally-carrying state by a vertically-carrying seat, and the vertically-carrying seat is supported by the infant carrier main body, wherein a back board formed by a hard material is provided on the infant carrier main body.

According to the infant carrier of the second aspect of the present invention, because the back board functions as a core material to restrain the deformation of the infant carrier main body, the deformation in the shape of the infant carrier main body caused by the load imparted when it is used can be prevented. Therefore, when the infant carrier main body is fixed to a plurality of points such as around the shoulder or around the waist to disperse the load, the load imparted to the infant carrier main body can be dispersed to each fixed positions as it is intended. Thereby, concentration of the load on a local part of the user is prevented. Therefore, the burden applied to the user can be relieved.

In the infant carrier according to the second aspect of the present invention, if the back board is hard compared to a cushioning material or a face fabric used for the infant carrier main body and the deformation caused by the load of the infant carrier main body may be restricted, it is enough. The back board does not have to be the rigid body such as to prevent deformation of the infant carrier main body completely, but the back board may have the elasticity so as to fit to the user to some extent.

In the infant carrier of the second aspect of the present invention, a shoulder belt mounted around a shoulder of a user is attached to an upper end portion of the infant carrier main body, a waist touching portion put on around a waist of the user is provided on a lower end portion of the infant carrier main body, and the back board may extended along a top-and-bottom direction from an attached position of the shoulder belt to the waist touching portion. In this case, the load can be dispersed from the shoulder to around the waist by the back board.

Further, on the lower part of the back board, a folding portion which is foldable upwardly may be provided. For example, when the user who has put on the infant carrier main body applies the vertically-carrying seat to the infant with the infant is made to sit on it, and attaches it to the infant carrier main body, there is a risk that the user cannot take suitable state because the lower part of the infant carrier main body touches to the surface where the infant sitting on. In this case, if the back board is foldable upwardly, the infant carrier main body does not become obstacle, thus the infant can be accommodated in the infant carrier smoothly. A folding axis of the folding portion may be located upper than the upper end of the waist touching portion. In this case, even though the waist touching portion has some rigidity, there is no risk that the bending of the folding portion is limited thereby.

An underarm belt to be joined to the infant carrier main body through the under arm of the infant may be provided on the vertically-carrying seat. By providing the underarm belt, because the infant can be pulled up from the underarm to the infant carrier main body, the infant can contact to the infant carrier main body more closely. Thereby, the risk that the load concentrates on the lower part of the vertically-carrying seat by the head and the chest of the infant being away from the infant carrier main body is disappeared.

Further, when the rigidity of the vertically-carrying seat is set lower than the back board, the vertically-carrying seat is made to be fit to the infant and can be pulled to the infant carrier body side more evenly, therefore it is preferable.

Much further object of the present invention is to provide an infant carrier in which, even though a vertically-carrying seat constructed as a separated part is mounted on an infant carrier main body and a bag-like portion in which an infant is accommodate is formed, a depth of the bag-like portion can be adjusted.

To achieve above described object, an infant carrier according to the third aspect of the present invention is an infant carrier in which a vertically-carrying seat constructed as a part separated from an infant carrier main body is mounted on the infant carrier main body which a user put on and a bag-like portion for accommodating an infant vertically is formed between the infant carrier main body and the vertically-carrying seat, wherein a sheet fastening portion for fastening the vertically-carrying seat is provided on the infant carrier main body, a bottom supporting portion folded back to the seat fastening portion of the infant carrier main body so as to form a bottom portion of the bag-like portion of the infant carrier main body is provided on a lower portion of the vertically-carrying seat, and a joining tool capable of joining to the sheet-fastening portion is provided on a distal end of the bottom supporting portion so that the position is adjustable along the top-and-bottom direction of the vertically-carrying seat.

The infant carrier according to the third aspect of the present invention, by changing the position of the joining tool along the top-and-bottom direction of the vertically-carrying seat, joining position of the vertically-carrying seat relative to the seat fastening portion can be changed along the top-and-bottom direction. Therefore, by changing the depth of a bottom portion formed by the bottom supporting portion of the vertically-carrying seat, the bag-like portion can be made to have the depth optimum to a physique of the infant.

In the infant carrier according to the third aspect of the present invention, either one of male and female buckles capable of being engaged with each other is provided on the sheet fastening portion, the other buckle is attached to the bottom supporting portion of the vertically-carrying seat through an adjust belt extended along the top-and-bottom direction as a joining portion, and an attaching position to the adjust belt of the other buckle may be adjustable. According to such an aspect, the depth of the bottom supporting portion can be changed only by changing the attached position of the buckle along the adjust belt.

In the infant carrier according to the third aspect of the present invention, a plural pairs of the buckles may be provided on each of the sheet fastening portion and the bottom supporting portion. By providing a plural pairs of buckles, even if one buckle falls off, the joining between the bottom supporting portion and the infant carrier main body is maintained by the remaining buckles. Therefore, the safeness is improved.

Further, a swing-preventing band to sandwich the bottom supporting portion therebetween may be provided on a position lower than the sheet-fastening portion of the infant carrier main body. When the joining portion is sent to the distal end (the bottom end) of the bottom supporting portion and the depth of the bottom supporting portion is made to be great, the distance from the bottom end of the bottom supporting portion to the joining portion and the sheet-fastening portion increases, and the bottom supporting portion becomes easy to swing. In this case, if the joining tool is joined to the sheet-fastening portion after the bottom supporting portion is sandwiched in the swing-preventing band, the bottom supporting portion is restricted by the infant carrier main body at the position under than the joining portion of the joining tool, thus the bottom supporting portion becomes hard to swing.

To achieve above described object, an infant carrier according to the forth aspect of the present invention is an infant carrier in which a vertically-carrying seat constructed as a part separated from an infant carrier main body is mounted on the infant carrier main body which user put on, and a bag-like portion for accommodating an infant vertically is formed between these infant carrier main body and the vertically-carrying seat, wherein a plurality of sheet fastening portions for fastening the vertically-carrying seat is provided on the infant carrier main body with each positions thereof shifted along the top-and-bottom direction, a bottom supporting portion folded back to the seat fastening portion of the infant carrier main body so as to form a bottom portion of the bag-like portion is provided on a lower portion of the vertically-carrying seat, and a joining tool capable of selectively joining to either one of the sheet-fastening portions is provided at the distal end of the bottom supporting portion.

According to the infant carrier of the fourth aspect of the present invention, by changing the sheet-fastening portion to joint the joining tool, the joining position of the bottom supporting portion for the infant carrier main body can be changed, thereby the depth of the bottom supporting portion can be changed.

Much further object of the present invention is to provide an infant carrier in which an infant carrier main body can be put on by a user adequately regardless of a supporting state of an infant.

To achieve above described object, an infant carrier according to the fifth aspect of the present invention is an infant carrier, in which a vertically-carrying seat constructed as a separated part from an infant carrier main body is mounted on the infant carrier main body which a user put on either of a chest or a back selectively, an infant is supported in a vertically-carrying state or a back-carrying state depending on a direction of the vertically-carrying seat, and a vertically-carrying seat is supported by the infant carrier main body, wherein the infant carrier main body comprises a base portion made to be touched to a chest of a back of the user, a shoulder belt extended from a base portion and mounted around a shoulder of the user, and the waist touching portion mounted around a waist of the user, and the waist touching portion is made to be displaced relative to the base portion along a top-and-bottom direction.

As described above, mainly when the infant is vertically-front-carried, the shoulder belt is used in a cross-hanging state, and when the infant is vertically-back-carried, the shoulder belt is used in a ruck-hanging state. When it is used in such a dual-purpose, if the position of the waist touching portion is unchangeable, the waist touching portion rises to the vicinity of the chest of the user in the backing-carrying state, and to the contrary, the infant is slipped down from the user, and then the backing carrying position sometimes becomes lower than required. According to the present invention, if such an inconvenience occurred, by displacing the waist touching portion under relative to the base portion, the position of the waist touching portion is made to be lower, then the user becomes to be able to put on the infant carrier maim body adequately. Thereby, the infant can be maintained in high position closely contacted to the user. When it is used in the vertically-carrying state, the waist touching portion may be raised upper than when it is used in the backing-carrying state. In this way, according to the fifth aspect of the present invention, the infant carrier main body can be put on by the user in both of the vertically-carrying state or the back-carrying state adequately. Because an attaching of the infant carrier main body is conducted adequately, as a result, the load is dispersed to the shoulder and the waist of the user, and then the burden to the user can be relived.

In the infant carrier according to the fifth aspect of the present invention, means for holding the waist touching portion at either of a plurality of pre-decided positions relative to the base portion is provided on the base portion. A pocket capable of receiving a lower end portion of the base portion may be provided on the waist touching portion, a folding portion which can be folded within the pocket may be provided on a lower end of the base portion, and a lower end of the folding portion may be joined to the waist touching portion. By such a configuration, while the base portion and the waist touching portion are made to be continued, the waist touching portion is provided relatively displaceable along the top-and-bottom direction for the base portion, Further object of the present invention is to provide an infant carrier in which the usability can be improved or the amenity of an infant can be raised when a horizontally-carrying seat or a vertically-carrying seat constructed as a part separated from an infant carrier main body is mounted on the infant carrier main body.

To achieve above described object, an infant carrier according to the sixth aspect of the present invention is an infant carrier comprising an infant carrier main body which is put on by a user and a horizontally-carrying seat to be suspended from the infant carrier main body for holding an infant in a horizontally-carrying state, wherein a pair of right-and-left fastening for hanging the horizontally-carrying seat is provided on the infant carrier main body, and a head side hang tool for hanging the head side of the horizontally-carrying seat from the fastening of either one of the pair of fastenings and a buttocks side hang tool for hanging the buttocks side of the horizontally-carrying seat from the other fastening are provided on the horizontally-carrying seat, and lengths of each hang tools are set so that the head side of the horizontally-carrying seat can be held in a position higher than the buttocks side when the head side hang tool and the buttocks side hang tool are mounted on one side fastening and the other fastening.

According to the infant carrier of the sixth aspect, the state to support the head in a position higher than the buttocks is guaranteed, and there is no risk that the infant is supported in the unnatural state in which the head of the infant fell down lower than the buttocks because of insufficient adjustment of the user. Therefore, the amenity of the infant is not diminished.

To achieve above described object, an infant carrier according to the seventh aspect of the present invention comprising an infant carrier main body to be put on by a user and a horizontally-carrying seat to be suspended from the infant carrier main body for holding an infant in a horizontally-carrying state, wherein, a head side hang tool and a buttocks side hang tool for hanging a head side and a buttocks side of the horizontally-carrying seat from the infant carrier main body are provided on the horizontally-carrying seat, the head side hang tool is provided so as to support the head side of the horizontally-carrying seat on both sides of the width direction of the horizontally-carrying seat, and the buttocks hang tool is provided so as to support the buttocks side of the horizontally-carrying seat at three points of both sides of the width direction of the horizontally-carrying seat and a middle of a width direction of a back end of the horizontally-carrying seat.

According to the infant carrier of the seventh aspect, the head side and the buttocks side of the horizontally-carrying seat are supported on both sides of the width direction, and are also supported on a middle of the width direction at the back of the buttocks side, thus the twist of the horizontally-carrying seat around a center line of a width direction of the horizontally-carrying seat is prevented, therefore the infant can be supported along the center line of the width direction straightly without twisted. Consequently, the amenity of the infant is improved.

In infant carrier according to the seventh aspect, the buttocks side hang tool has an abdomen belt extended form both sides of a width direction of the horizontally-carrying seat, a buttocks belt extended from the center of a width direction of the horizontally-carrying seat back end, and an abdomen pad arranged at the back end portion of the horizontally-carrying seat and covers the abdomen of the infant, and by the abdomen belt and the buttocks belt being connected each other through the abdomen pad, the abdomen belt and the buttocks belt may be made to be capable of being hung and supported integrally from the infant carrier main body.

According to this aspect, by utilizing the abdomen pad, the abdomen belt and the buttocks belt can be hung integrally and the buttocks side of the horizontally-carrying seat can be supported certainly at the above described three points.

Further, on a back end portion of the horizontally-carrying seat, a buttocks supporting portion for supporting a buttocks of the infant and a leg supporting portion which is foldable to the buttocks supporting portion and for supporting the legs of the infant are provided, an abdomen belt is extended form the both sides of the width direction of the buttocks supporting portion, while a buttocks belt may be extended from a center of a width direction of the back end of the legs.

According to this aspect, when the horizontally-carrying seat is removed from the infant carrier main body and it is let down on such as bedclothes, the buttocks supporting portion and the leg supporting portion extend straightly and a portion from the buttocks to the legs of the infant is maintained horizontally. On the other hand, when the horizontally-carrying seat is hung and supported from the infant carrier main body, the leg supporting portion bents obliquely upward to buttocks supporting portion because the buttocks belt is pulled up to the leg supporting portion. Thereby, the natural horizontally-carrying state in which the legs are lifted upper than the buttocks is realized, and the amenity of the infant is improved.

In described above aspect, a back board as a core material to support the infant may be embedded in the horizontally-carrying seat, and the back board may be made to bent by a load occurred when the infant is supported with a central line of a width direction being bottom.

By providing such a back board, the twist of the horizontally-carrying seat is prevented more surely. Moreover, because of the deformation of the back board, the infant laid on the horizontally-carrying seat is moved to the center line of the width direction, and the horizontally-carrying state can be further stabilized.

To achieve the above descried object, an infant carrier according to the eighth aspect of the present invention comprising an infant carrier main body to be put on by a user and a horizontally-carrying seat to be suspended from the infant carrier main body for holding an infant in a horizontally-carrying state, wherein a mat for laying an infant and a head guard arranged to surround a head of an infant is provided on the horizontally-carrying seat, a core material is provided on the mat and the head guard respectively, and a vent is provided on each core material.

According to the infant carrier of the eighth aspect, because moisture is released through the vent of the head guard and the mat, a permeability of the horizontally-carrying seat is improved, and the amenity of the infant laid in the horizontally-carrying seat is improved.

To achieve above described object, an infant carrier according to the ninth aspect of the present invention comprising an infant carrier main body to be put on by a user and a horizontally-carrying seat to be suspended from the infant carrier main body for holding an infant in a horizontally-carrying state, wherein a back board as a core material supporting from the head to the buttocks of the infant and a seating board as a core material for supporting legs of the infant are embedded in the horizontally-carrying seat, and the seat is enlarged in width direction wider than a buttocks edge portion of the back board.

According to the infant carrier of the ninth aspect, when the horizontally-carrying seat is hung from the infant carrier main body, because of the seat broad with a core material, enough space can be provided around the legs of the infant. Thereby compression to the legs of the infant is prevented, and the amenity of the infant can be improved.

To achieve above described object, an infant carrier according to the 10th aspect of the present invention comprising an infant carrier main body to be put on by a user and a vertically-carrying seat for forming a back-like portion to accommodate an infant vertically between the infant carrier main body by being combined with the infant carrier main body, wherein a ring-like fastening to fasten the vertically-carrying seat is provided on the infant carrier main body, a seat main body for moving the infant toward the infant carrier main body, and a joining belt extending from the seat main body for joining the vertically-carrying seat to the fastening are provided on the vertically-carrying seat, either one of a pair of the male and female buckles capable of being engaged each other is provided on the joining belt and the other buckle is provided on the seat main body respectively, the one of the buckles is capable of passing through the fastening, an excess length portion of the joining belt is drawn from the one of the buckles so as to be folded back, and in the state that the one of the buckles is passed through the fastening, the excess length portion hangs in the fastening, and the one of the buckles becomes incapable of passing through the fastening.

According to the infant carrier of the 10th aspect, if the buckle provided on the joining belt of the vertically-carrying seat is made to be passed through the fastening of the infant carrier main body, even if the buckles are disengaged each other, one of the buckles cannot pass through the fastening, thus there is no risk that the joining belt is completely released from the fastening. Consequently, the safeness is improved, and for the user who is inexperienced in the mounting of the joining belt, it is not necessary to pass the buckle of the joining belt side through the fastening many times, therefore it is convenient.

To achieve above described object, an infant carrier according to the 11th aspect of the present invention comprising an infant carrier main body to be put on by a user and a vertically-carrying seat for forming a back-like portion to accommodate an infant vertically between the infant carrier main body by being combined with the infant carrier main body, wherein a head support for covering the head of an infant, a support belt extending from both sides of the head support for joining to the infant carrier main body are provided on the vertically-carrying seat, the head support is foldable toward the outside of the vertically-carrying seat, the support belt can be joined to the infant carrier main body so that the twist of the support belt is dissolved when the head support is folded back in a half-turned state.

According to the infant carrier of the 11th aspect, the head support can be folded outwardly without removing the support belt from the infant carrier main body, therefore it is convenient.

To achieve above described object, an infant carrier according to the 12th aspect of the present invention comprising an infant carrier main body to be put on by a user and a vertically-carrying seat for forming a back-like portion to accommodate an infant vertically between the infant carrier main body by being combined with the infant carrier main body, wherein a ring-like fastening to fasten the vertically-carrying seat is provided on the infant carrier main body, and the fastening bends so as to project to the infant carrier main body side seeing from the side.

According to the infant carrier of the 12th aspect, the projection of the fastening toward the back-like portion formed between the infant carrier main body and the vertically-carrying seat is restrained, and the risk that the fastening comes in contact with the infant is reduced. Thereby, the amenity for the infant is improved.

To achieve above described object, an infant carrier according to the 13th aspect of the present invention comprising an infant carrier main body to be put on by a user and a vertically-carrying seat for forming a back-like portion to accommodate an infant vertically between the infant carrier main body by being combined with the infant carrier main body, wherein an inner packing material having a vent hole is embedded in the vertically-carrying seat, and the inner packing material is covered with a three-dimensional mesh fabric.

According to the infant carrier of the 13th aspect, permeability of the back-like portion covered by the vertically-carrying seat is improved, and the amenity for the infant is increased.

To achieve above described object, an infant carrier according to the 14th aspect of the present invention comprising an infant carrier main body to be put on by a user and a vertically-carrying seat for forming a back-like portion to accommodate an infant vertically between the infant carrier main body by being combined with the infant carrier main body, and an infant can be put in the back-like portion directing either of a forward-looking or a backward-looking directions, and a width of the lower of the vertically-carrying seat is adjustable.

When the infant is carried in the forward-looking state, the lower portion of the vertically-carrying seat functions to force the crotch portion of the infant to the infant carrier main body side, however, when the infant is carried in a backward-looking state, that is a state directing to the user, the lower part of vertically-carrying seat functions to move the buttocks of the infant to the infant carrier main body side. By the difference of these functions, the optimum width required to the lower part of the vertically-carrying seat changes, in the forward-looking state, it is more preferable that the width of the vertically-carrying seat is smaller than the back-looking state. According to the infant carrier of the 14th aspect of the present invention, the width of the lower part of the vertically-carrying seat is made variable in response to such a demand, therefore the vertically-carrying seat can be adjusted to the optimum width depending on the direction of the infant.

To achieve the above described object, an infant carrier according to the 15th aspect of the present invention comprising an infant carrier main body to be put on by a user and a vertically-carrying seat for forming a back-like portion to accommodate an infant vertically between the infant carrier main body by being combined with the infant carrier main body, wherein a shoulder belt mounted around a shoulder of the user is provided on the infant carrier main body with length adjustable, a shoulder belt band for folding and holding an excess length portion of the shoulder belt which length thereof has been adjusted is provided.

According to the infant carrier of the 15th aspect, the excess shoulder belt can be held with being folded into the band without leaving it in a suspended state, regardless of a physique of the user and a mounting form of the infant carrier main body, the shoulder belt can be folded up so as not to be obstacle, therefore, it is convenient.

Further object of the present invention is to provide a joining structure of a belt-shaped article capable of fixing a buckle to a fixed portion adequately and capable of dissolving above described inconvenience, and to provide an infant carrier which utilize the joining structure and a fixing side buckle which can be used for the joining structure.

To achieve above described object, a joining structure of the present invention is of a belt-shaped article, in which either one of a pair of male and female buckles capable of engaging each other is attached to the belt-shaped article, the other buckle is attached to the fixed portion to be joined to the belt-shaped article, and the belt-shaped article and the fixed portion are made to be detachable, wherein the buckle attaching to the fixed portion is fixed to the fixed portion at the back and forth of the buckle relative to an attaching or a detaching direction of the belt-shaped article.

According to such joining structure, the fixed side buckle (the other buckle) is fixed to the fixed portion at the back and forth thereof, therefore a play of the front edge side of the fixed side buckle is restrained, and the buckles are easily aliened and is engaged each other. When tensile load acts on the fixed side buckle by tension of the belt-shaped article, the tensile load is received in the fixed portion at back and forth of the fixed side buckle. Therefore, comparing to the case when only the back end side of the fixed side buckle is fixed to the fixed portion, the load imparted to the fixed side buckle can be dispersed widely. Further, by binding back and forth of the fixed side buckle, the direction of the fixed side buckle can be determined in a suitable state beforehand, thus the risk that the fixed side buckle is joined to the belt-shaped article in an unnatural direction can be eliminated.

In the joining structure of the present invention, belt through portions may be provided on each of front and back ends of the buckle attached to the fixed portion, and a buckle fixing belt may be made to be passed through between these belt through portions, and both end portions of the buckle fixing belt may be fixed to the fixed portion. According to such configuration, one end of the buckle fixing belt which is conventionally wound in a loop-like and folded back on the end side of the buckle is extended to the front edge of the buckle and is made to be passed through the belt through portion, and the both end portions of the buckle fixing belt are fixed by sewing on the fixed portion, therefore, according to the present invention, the fixed side buckle can be fixed to the fixed portion.

To achieve above described object, an infant carrier according to the 16th aspect of the present invention comprising an infant carrier main body provided with a shoulder belt to be put on around a shoulder of a user and a waist touching portion to be put on around a waist of the user, either one of a pair of mutually engagable male and female buckles is attached to the shoulder belt and the other buckle is attached to the waist touching portion, and the shoulder belt and the waist touching portion are made to be detachable, wherein a buckle attached to the waist touching portion is fixed to the waist touching portion at back and forth of the buckle relative to the attaching or detaching direction of the shoulder belt.

According to the infant carrier of the 16th aspect, the above described effect of the joining structure can be obtained, and further, especially the tension of the shoulder belt can be made to disperse and to act widely over the waist touching portion, the waist touching portion is pulled to the user side over the wide area, and local bias of the load to the user can be restricted, thereby stability of the waist touching portion can be increased.

According the infant carrier of the 16th aspect, belt through portions may be provided on each of front and back ends buckles attached to the waist touching portion, and the buckle fixing belt may be made to be passed through between these belt through portions, and the both end portions of the buckle fixing belt may be fixed to the fixed portion.

A fixing side buckle of the present invention is attached to a fixed portion to which a belt-shaped article is to be joined and a buckle fixed to the belt-shaped article is attached and detached, wherein belt through portions are provided at front and back ends relative to an attaching or detaching direction of the belt-shaped article, a buckle fixing belt for fixing the fixed side buckle to a fixed portion is made to be capable of inserting between the belt through portions. According to such a fixed side buckle, by fixing the buckle fixing belt to the fixed portion at back and forth of the fixed side buckle, the joining structure of the present invention can be realized.

Further object of the present invention is to provide an infant carrier capable of restricting a swing of a horizontally-carrying seat when the horizontally-carrying seat is hung from an infant carrier main body. Further, to provide an infant carrier capable of distinguishing an appropriate fastening easily when a plurality of fastenings are provided on the infant carrier main body, and to provide an infant carrier capable of covering a chest portion of an infant held in a horizontally-carrying state.

To achieve the object mentioned above, an infant carrier according to the 17th aspect of the present invention comprising an infant carrier main body to be put on by a user and a horizontally-carrying seat to be suspended from the infant carrier main body for holding an infant in a horizontally-carrying state, wherein on the infant carrier main body, as fastenings for attaching the horizontally-carrying seat, an upper part fastening for hanging the horizontally-carrying seat and a lower part fastening disposed under than the upper fastening is provided on the infant carrier main body, and on the horizontally-carrying seat are provided, a hang tool for hanging the horizontally-carrying seat from the upper fastening and a swing-stopping fastening provided on the one side of the width direction of the horizontally-carrying seat and can be joined to the lower part fastening are provided.

According to the infant carrier of the 17th aspect, by joining the lower part fastening of the infant carrier main body and the swing-stopping fastening of the horizontally-carrying seat each other, the horizontally-carrying seat can be restricted to the infant carrier main body at the position under than the joining position between the upper fastening and the hang tool. Thereby, the swing around the hanging support point of the horizontally-carrying seat is restricted, and then the burden to the user can be reduced.

In the infant carrier of the 17th aspect, a pair of shoulder belts to be put on around a shoulder of a user and a waist belt to be put on around a waist of the user continuously from an under end of the shoulder belt are provided on the infant carrier main body, the upper fastening may be provided on respective middle of the pair of shoulder belts, the lower part fastening may be provided on a bottom end of the shoulder belt or the waist belt. According to this aspect, by separating the lower part fastening from the upper fastening relative to the under direction in maximum, the swing-preventing effect by the swing-preventing fastening can be exerted more effectively. The words “bottom end of the shoulder belt” or “waist belt” contains borders of both.

Further, each of the lower part fastening and the swing-preventing fastening are attached to the infant carrier main body and the horizontally-carrying seat through the fastening fixing belt, and at a position adjacent to each of the lower part fastening and the swing-preventing fastening, the fastening fixing belt can be sewn on the infant carrier main body and the horizontally-carrying seat. According to this aspect, a lifting of the lower part fastening from the infant carrier main body and the swing of the swing-preventing fastening itself around the horizontally-carrying seat can be restricted, thus the swing-preventing effect by the swing-preventing fastening can be further exerted.

In infant carrier according to the 17th aspect, a left and right pair of upper fastenings is provided on a infant carrier main body, and on the horizontally carrying seat, as a hang tool, a head side hang tool for hanging the head side of the horizontally carrying seat from the upper fastening of either one of the pair of upper fastenings, and a buttocks side hang tool for hanging the buttocks side of the horizontally carrying seat from the other upper fastening may be provided. According to this aspect, the load imparted to the hang tool of the horizontally carrying seat is dispersed to the both shoulders of the user and a swing of the horizontally carrying seat can be restrained by the lower part fastening and the swing-preventing fastening, thus the burden to the user can be further reduced.

Further, in the above-descried aspect, an abdomen pad covering an abdomen of the infant may be provided on the buttocks support side of the horizontally-carrying seat, a chest pad covering a chest of the infant may be continuously provided on the upper end of the abdomen pad, a chest belt joining the head side hang tool and the chest pad may be provided on the horizontally-carrying seat. According to this aspect, by covering the area from the abdomen to the chest of the infant with the abdomen pad and the chest pad, the area can be protected. By joining the chest pad to the head side hang tool, the hanging of the chest is prevented and the increase of the unpleasantness of the infant caused by adding the chest pad is restricted.

In infant carrier of the 17th aspect, the upper fastening and the lower part fastening may be different each other in at least either one of structures relating to size or joining. By distinguishing fastenings as such, when the horizontally-carrying seat is mounted on the infant carrier main body, it becomes impossible to joint the hang tool or the swing-preventing fastening to unsuitable fastening, thus the appropriate fastening can be easily and certainly distinguished.

In infant carrier of the 17th aspect, an abdomen pad covering the abdomen of the infant may be provided on the buttocks side of the horizontally-carrying seat, and a chest pad covering a chest of the infant may be provided continuously to the upper end of the abdomen pad. Thereby, from the abdomen to the chest of the infant is covered, and the protection thereof is achieved.

To achieve above described object, an infant carrier according to the 18th aspect of the present invention comprising an infant carrier main body to be put on by a user and an attachment to be joined to the infant carrier main body for holding the infant, wherein on the infant carrier main body, a plurality kinds of fastenings used for mutually different purposes respectively for joining the attachment are provided in different positions, and each of the fastenings of the plurality kinds of fastenings are different each other in at least either one of size or structure relating to joining. According to the infant carrier of this aspect, because the configuration relating to the size or the joining of the fastening of a plurality of the applications is different from each other, the appropriate fastening depending on an application can be distinguished easily.

To achieve above described object, an infant carrier according to the 19th aspect of the present invention comprising an infant carrier main body to be put on by a user and a horizontally-carrying seat to be suspended from the infant carrier main body for holding an infant in a horizontally-carrying state, wherein an abdomen pad covering an abdomen of an infant is provided on a buttocks side of the horizontally-carrying seat, and a chest pad covering a chest of the infant is provided continuously at an upper end of the abdomen pad. According to the infant carrier of this aspect, the area from the abdomen to the chest of the infant is covered with the abdomen pad and the chest pad, thus those can be protected.

In the present invention, the terminology of an infant is used as a concept including a newborn baby and a baby.

### BRIEF DESCRIPTION OF THE DRAWINGS

FIG. 1 is views showing a usage state of an infant carrier according to one embodiment of the present invention;

FIG. 2 is a front view of the infant carrier main body;

FIG. 3 is a rear view of the infant carrier main body;

FIG. 4 is a front view of a back board embedded in the infant carrier main body;

FIG. 5 is a perspective view showing a joining structure between a base portion and a waist touching portion of the infant carrier main body;

FIG. 6 is views showing a fastening used for the infant carrier main body;

FIG. 7 is a view showing a state in which an excess length portion at a shoulder belt of the infant carrier main body is bundled by the band;

FIG. 8 is a perspective view showing a female buckle provided on the waist touching portion of the infant carrier main body;

FIG. 9 is a view showing an attached state of the female buckle provided on the waist touching portion of the infant carrier main body;

FIG. 10 is a perspective view of the waist touching portion of the infant carrier main body;

FIG. 11 is a plan view of a horizontally-carrying seat;

FIG. 12 is a plan view of a back board embedded in the horizontally-carrying seat;

FIG. 13 is a plan view of a core material embedded in a head guard of the horizontally-carrying seat;

FIG. 14 is a perspective view of a hanging board provided on the horizontally-carrying seat;

FIG. 15 is a plan view of the hanging board;

FIG. 16 is a bottom view of the hanging board;

FIG. 17 is a perspective view of a core material embedded in the hanging board;

FIG. 18 is a perspective view showing a state in which the horizontally-carrying seat is mounted on the infant carrier main body;

FIG. 19 is a view, seeing form a head side of the infant, showing a state in which the horizontally-carrying seat is mounted on the infant carrier main body;

FIG. 20 is views showing setting states of the hanging belt;

FIG. 21 is views showing a relation between a stopper and a fastening of the hanging belt;

FIG. 22 is a view showing a state in which the infant carried in the horizontally-carrying seat is seen from a direction facing to the user;

FIG. 23 is a view showing a state in which the infant carried in the horizontally-carrying seat is seen from an upper side;

FIG. 24 is a view showing the state in which the infant carried in the horizontally-carrying seat is seen from a foot side;

FIG. 25 is a front view of a vertically-carrying seat;

FIG. 26 is a back view of the vertically-carrying seat;

FIG. 27 is a further front view of the vertically-carrying seat;

FIG. 28 is a perspective view showing a state in which the vertically-carrying seat is mounted on the infant carrier main body;

FIG. 29 is a view showing steps to joint a bottom supporting portion of the vertically-carrying seat to the infant carrier main body;

FIG. 30 is views showing another procedure to joint the bottom supporting portion of the vertically-carrying seat to the infant carrier main body;

FIG. 31 is views showing another embodiment about a joining structure between the infant carrier main body and the vertically-carrying seat;

FIG. 32 is views showing still other embodiment about the joining structure between the infant carrier main body and the vertically-carrying seat more;

FIG. 33 is a perspective view showing the state in which a head support of the vertically-carrying seat mounted on the infant carrier main body is folded back;

FIG. 34 is a front view of an infant carrier according to the second embodiment of the present invention;

FIG. 35 is a perspective view from a buttocks side of the infant carrier according to the second embodiment of the present invention;

FIG. 36 is a view showing the state in which the infant carrier main body is developed from back side;

FIG. 37 is a view showing a state when the infant carrier main body is put on by the user;

FIG. 38 is an extended view of a fastening portion of a lower part female buckle;

FIG. 39 is a plan view of the horizontally-carrying seat;

FIG. 40 is a development of the horizontally-carrying seat;

FIG. 41 is a perspective view of the hanging board;

FIG. 42 is a perspective view of the horizontally-carrying seat;

FIG. 43 is an extended view of a buttock side of the horizontally-carrying seat;

FIG. 44 is an extended view of a joining part between a chest pad and a hanging board;

FIG. 45 is an extended view seeing a joining part between a chest pad and a hanging board from the other side;

FIG. 46 is an extended view of the joining part between a male buckle and a lower part female buckle of the infant carrier main body for stopping a swing of the horizontally-carrying seat;

FIG. 47 is a front view of the vertically-carrying seat used in the infant carrier;

FIG. 48 is a back side view of the vertically-carrying seat;

FIG. 49 is a view showing a state in which the vertically-carrying seat is mounted on the infant carrier main body.

### DETAILED DESCRIPTION OF THE PREFERRED EMBODIMENTS

### First Embodiment

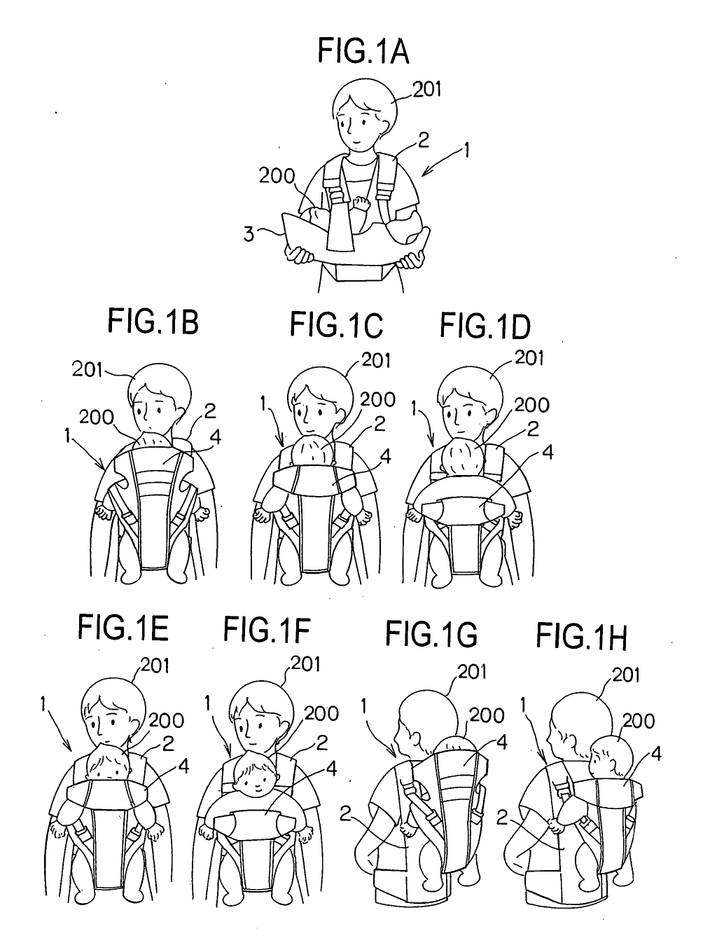

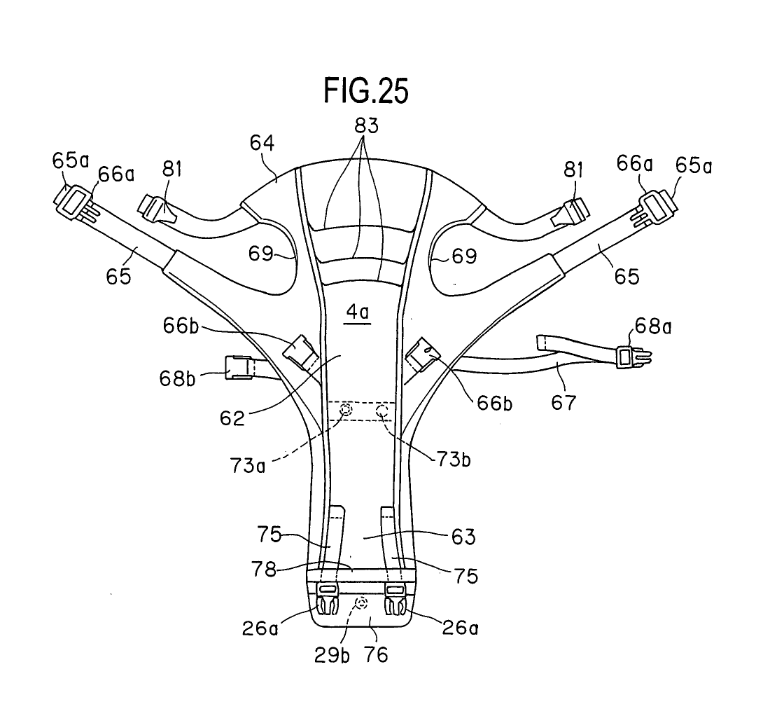

Hereinafter, the first preferred embodiment of an infant carrier to which the present invention is applied will be described. FIG. 1 shows an outline of the present invention. The infant carrier 1 can be used in many states: a horizontally-carrying state (FIG. 1(a)) in which an infant (including a baby) 200 is supported with being laid down substantially horizontally; a face-to-face-carrying state (FIG. 1(b) . . . (d)) in which an infant 200 is carried with his/her face directed to the user's face; a forward-looking-carrying state (FIG. 1(e), (f)) in which the infant 200 is carried in a forward-looking state; and a back-carrying state (FIG. 1(g), (h)) in which the infant 200 is carried on the user's back. Further, in the face-to-face-carrying state, the forward-looking-carrying state, or the backing-carrying state, a plurality of styles can be used by changing a folding position of a head support 64 respectively (with reference to FIG. 25).

In either case of the above four usages, a user 201 has to put on an infant carrier main body. In the horizontally-carrying state, a horizontally-carrying seat 3 is used in combination with an infant carrier main body 2, and in other states, a vertically-carrying seat 4 is used in combination with the infant carrier main body 2. In the followings, the construction of these components and how to use these components will be described sequentially.

[About Infant Carrier Main Body]

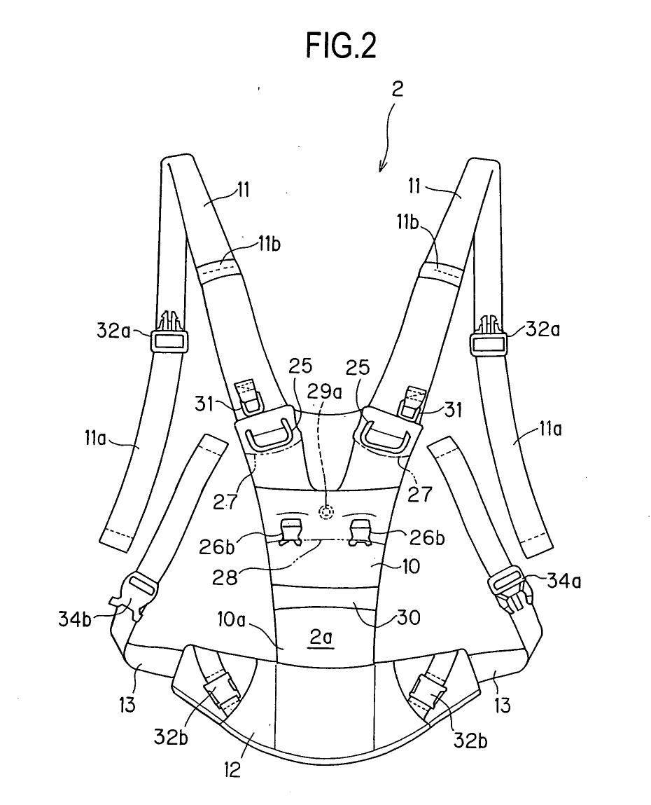

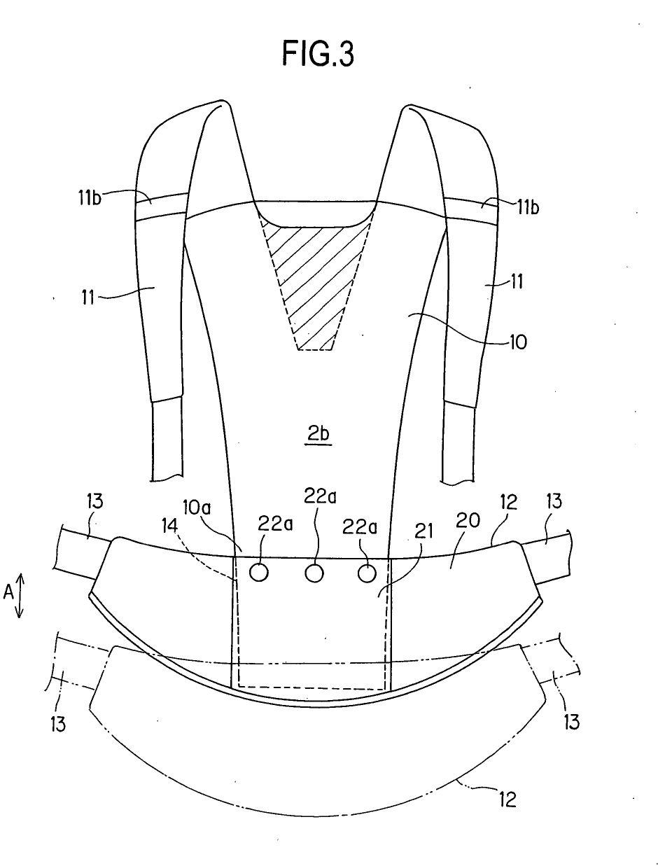

At first, the infant carrier main body 2 will be described. FIG. 2 is a view seeing the infant carrier main body 2 from a surface 2a side, and FIG. 3 is a view seeing it from a back face 2b side respectively. The infant carrier main body 2 can be put on either of a chest side or a back side of the user 201, however in either side, a back face 2b side shown in FIG. 3 faces to the user 201. In other words, the back face 2b is made to face to the chest or the back of the user 201. The top-and-bottom direction of FIG. 2 and FIG. 3 corresponds to the top-and-bottom direction when it is put on by user 201. As shown in these figures, the infant carrier main body 2 comprises a base portion 10 made to be faced to the chest of the back of the user 201, a pair of shoulder belt 11, 11 extending from the upper end of the base portion 10, a waist touching portion 12 provided under the base portion 10 and be put on around the waist or the user 201, and a pair of waist belts 13, 13 extending from the both sides of the waist touching portion 12.

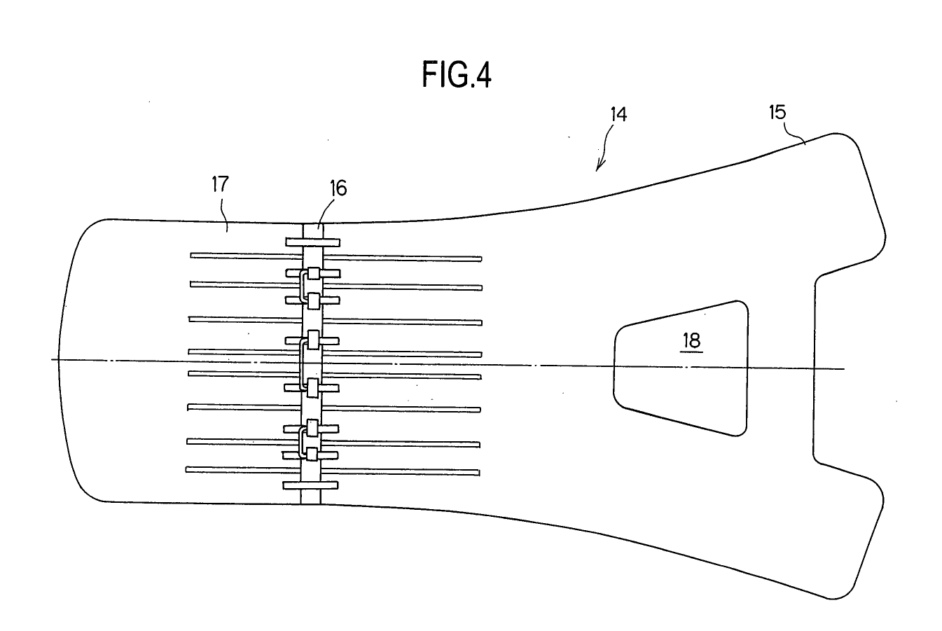

There is provided a back board 14 shown in FIG. 4 inside of the base portion 10. The back board 14 is a molding consisting of a hard resin material such as polypropylene resin, which is hard enough in comparison with such as urethane used for the core material of such as shoulder belt 11. A rigidity of the back board 14 is determined so as to restrict the elastic deformation of the base portion 10 occurred when the user 201 put on the infant carrier main body 2, and to maintain the shape of the base portion 10 substantially uniform. The back board 14 is embedded in the base portion 10 with the right side potion of FIG. 4 conformed to the upper side of the base portion 10. The back board 14 has a branching portion 15 at the end corresponding to the attaching position of the shoulder belt 11, and a bending portion 17 turnable about a hinge axis 16 at the other end. On the branching portion 15, a through window 18 is provided to improve a permeability of the base portion 10. The back board 14 inserted in the base portion 10 is covered with a face fabric. Various materials such as all kinds of cloth, three-dimensional mesh fabric are used as a face fabric. A cushioning material may be provided between the back board 14 and the face fabric appropriately.

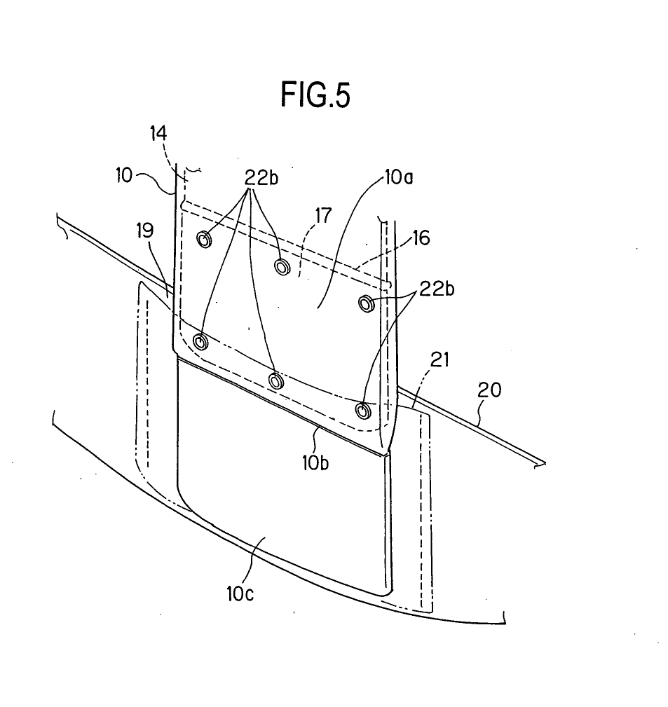

As also shown in FIG. 5, in the middle of the width direction (right-and-left direction of FIG. 3) of the waist touching portion 12, a pocket 19 is formed by sewing a cover 21 from the back side of a waist touching portion main body 20. A back board made by a hard material such as polypropylene resin is embedded in the cover 21 as a core material. The lower end portion 10a of the base portion 10 is inserted in the pocket 19, and the lower end thereof is sewn to the waist touching portion main body 20 and the cover 21. The back board 14 extends to the sewn portion 10b of the lower end portion 10a of the base portion 10, and a folding portion 10c in which the back board 14 is omitted is provided on a position lower than the sewn portion 10b. By folding or unfolding the folding portion 10c, the position of the waist touching portion 12 relative to the base portion 10 can be changed as shown in the FIG. 3 in an arrow A.

There are provided snaps 22b . . . 22b on the lower end portion 10a of the base portion 10 for preventing displacement between the base portion 10 and the waist touching portion 12 by engaging with snaps 22a (with reference to FIG. 3) of the waist touching portion 12 at each of the folded position or the unfolded position of the folding portion 10c. For not diminishing the folding function of the folding portion 17 of the back board 14, even in the folded state in which the folding portion 10c is folded, the hinge axis 16 is located slightly upper than the pocket 19. Therefore, the infant carrier main body 2 is foldable about the hinge axis 16 regardless of the positional relationship of the base portion 10 and the waist touching portion 12.

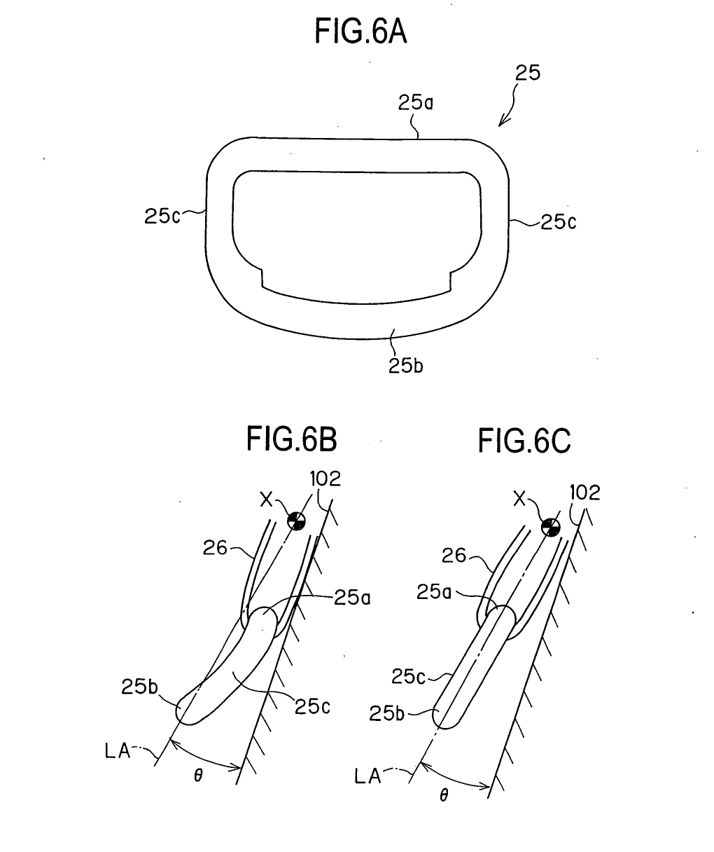

Returning to FIG. 2, at the upper part of the surface 2a side of the base portion 10, a pair of right-and-left fastenings 25, 25 is provided for fastening the horizontally-carrying seat 3 or a vertically-carrying seat 4. As shown in FIG. 6(a), a fastening 25 is formed as ring-like and comprising a supporting axis portion 25a, a hooking portion 25b apart from and in parallel with the supporting axis portion 25a, and connecting portions 25c, 25c connecting both ends of the supporting axis portion 25a and the hooking portion 25b respectively. Because the hooking portion 25b extends in an arc-shape and an entire shape of the fastening 25 forms substantially D-shape, the fastening 25 sometimes called as D-ring.

As shown in FIG. 6(b), the fastening 25 is fixed to a fixed portion 202 (the base portion 10 is an example) through a joining belt 26 which is wound around the supporting axis portion 25a, and the right-and-left connecting portions 25c (only one side is shown in FIG. 6(b)) are bend toward the fixed portion 202. By imparting such bending to the connecting portion 25c, the fastening 25 moves backward toward the fixed portion 202 side from the load action line LA which connecting the hooking portion 25b of the fastening 25 and the support point X of the fastening 25. For reference, if the connecting portion 25c is straight, the entire of the fastening 25 lies on the action line LA as show in FIG. 6(c). In other words, if the tilt angle e of the load action line LA relative to the fixed portion 202 is the same, the lifting of the fastening 25 from the fixed portion 202 can be restrained relatively smaller in the structure in which the connecting portion 25c is bent. The fastening 25 of the base portion 10 is used for hanging the horizontally-carrying seat 3 or the vertically-carrying seat 4, and the infant 200 is accommodated in front of the base portion 10, therefore if the fastening 25 is formed as shown in FIG. 6(b), the lifting of the fastening 25 from the base portion 10 is restrained, thereby the contact between the fastening 25 and the infant 200 is prevented, thus the comfortableness for the infant 200 is improved.

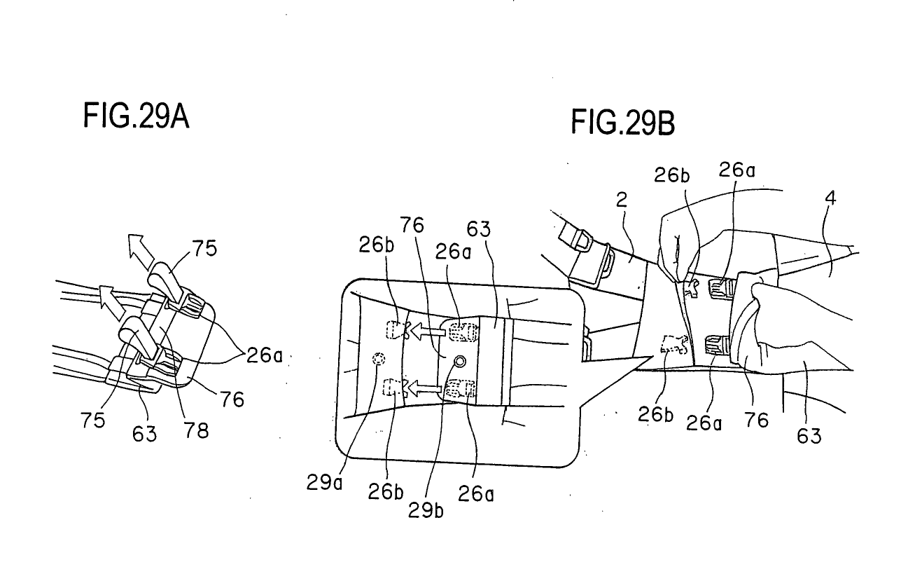

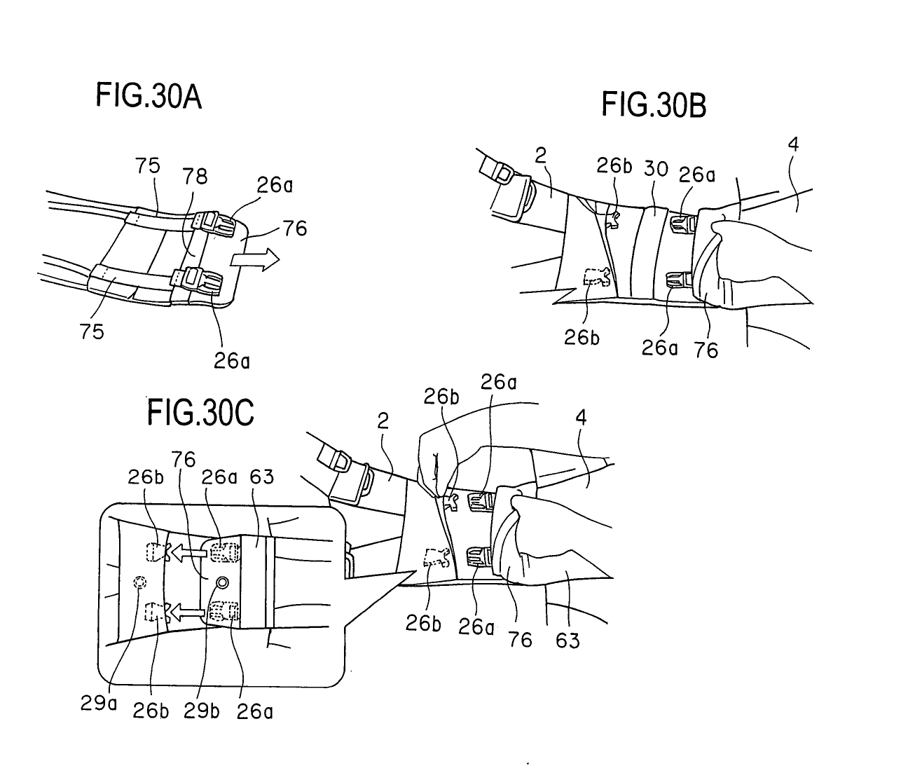

As shown in FIG. 2, female buckles 26b, 26b are provided to fasten the lower end portion of the vertically-carrying seat 4 of the base portion 10 (also with reference to FIGS. 29 and 30). Each female buckle 26b is fixed to the face fabric of the base portion 10 with the distal end of the inserting direction directed downwardly. Above described each fastening 25 and each the female buckle 26b is basically covered with flaps 27, 28 respectively. A snap 29a is attached to the back side of the flap 28 relative to the female buckles 26b (opposite side of the female buckles 26b). On the portion lower than the flap 28, a swing-preventing band 30 is provided so as to cross the base 10. The female buckles 26b are covered with the flap 28 so that the female buckles 26b and the male buckles 26a for engaging therewith (with reference to FIG. 25) do not touch the infant 200 when they are unused (for example in the horizontally-carrying state).

Supporting fastenings 31, 31 are attached around the base portions of each shoulder belt 11 (the portions joined to the base portion 10). These fastenings 31 are ring-like as same as the fastenings 25, but the size is smaller than the fastenings 25. Furthermore, male buckles 32a are attached to the distal ends of each shoulder belt 11 for fixing the shoulder belt 11 to the waist touching portion 12. On the other hand, female buckles 32b are attached to the waist touching portion 12 for engaging with the male buckles 32a of the shoulder belt 11. Each male buckle 32a can be engaged with both of the right-and-left female buckles 32b. That is to say, the infant carrier main body 2 can be put on by the user 201 in either state of: a cross-hanging state in which the shoulder belts 11 are crossing each other by joining the left shoulder belt 11 to the right female buckle 32b of the waist touching portion 12 and the right shoulder belt 11 to the left female buckle 32b of the waist touching portion 12; or a ruck-hanging state in which the shoulder belts 11 are un-crossing each other by joining the left shoulder belt 11 to the left female buckle 32b of the waist touching portion 12 and by joining the right shoulder belt 11 to the right female buckle 32b of the waist touching portion 12.

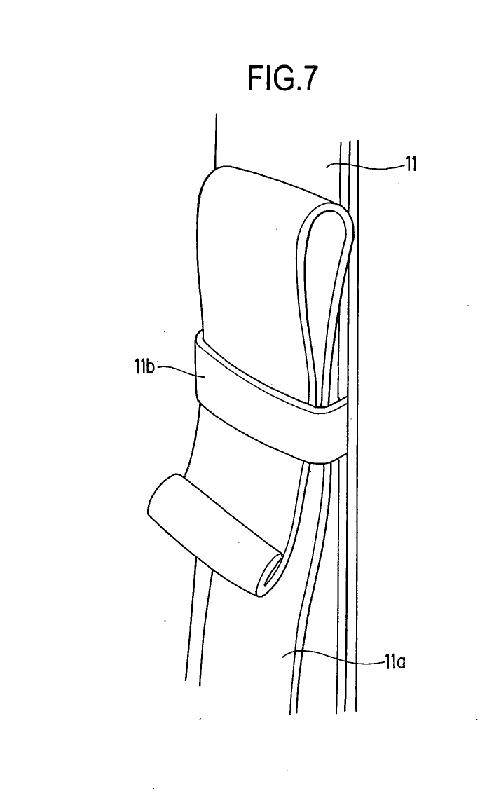

An attaching position of the male buckles 32a is adjustable about the longitudinal direction of the shoulder belt 11. Required length of the shoulder belt 11 changes in the cross-hanging state or the ruck-hanging state, but the adjustment is conducted by changing the attaching position on the male buckles 32a on shoulder belt 11. Of course, depending on the physique of the user 201, the position of the male buckles 32a can be adjusted. The shoulder belt 11 has enough length so that an enough excess portion 11a (it means the residual portion of the shoulder belt 11 drawn from the male buckle 32a) remains even though it is used in the cross-hanging state, therefore in the ruck-hanging, the length of the excess portion 11a of the shoulder belt 11 drawn form the male buckle 32a is expected to be a significantly increases. In addition, when the physique of the user 201 is small, the excess portion 11a increases regardless of the states of the hang shoulder belt 11. Therefore, as shown in FIG. 7, a band 11b is provided for holding the excess portion 11a with it folded.

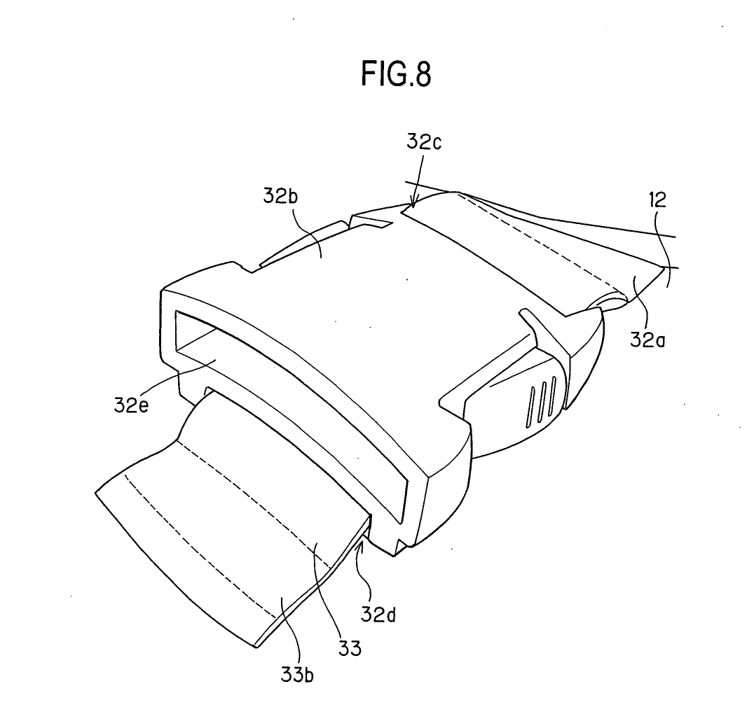

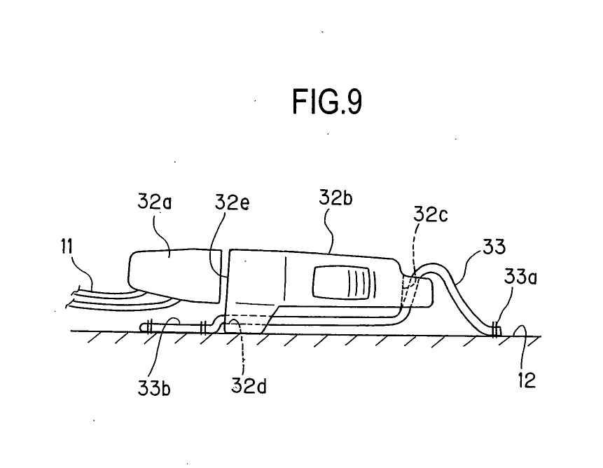

In addition, in the female buckle 32b provided on the waist touching portion 12, there is a feature which is different from a normal female buckle. As shown in FIGS. 8 and 9, at the back and front ends of the female buckle 32b, there are provided belt through portions 32c, 32d respectively. A side where an aperture 32e for receiving the male buckle 32a is provided is called a front end of the female buckle 32b. A buckle fixing belt 33 which is made to be passed through the belt through portion 32c of the back end side of the female buckle 32b is drawn from the belt through portion 32d of the front edge side forwardly to the female buckle 32b though the back side of the female buckle 32b. By sewing both ends portion 33a, 33b of this buckle fixing belt 33 on the waist touching portion 12, the female buckle 32b is fixed to the waist touching portion 12 which functions as a fixed portion along the back and forth direction which the male buckles 32a are inserted or pulled out.

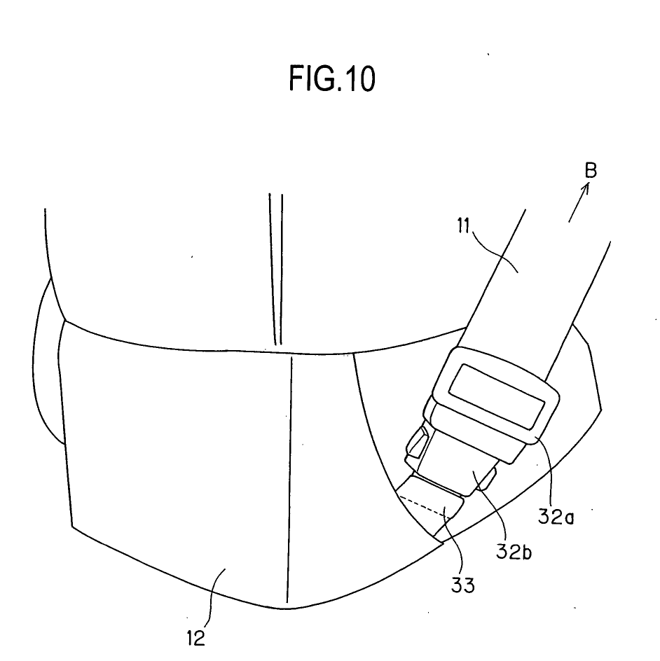

In a common female buckle, a belt through portion is provided only on the back end side thereof, and the front end side is not fixed. On the contrary, in the female buckle 32b shown in FIG. 8 and 9, the front end and the back end are fixed to the waist touching portion 12. Therefore, as shown in FIG. 10, when the shoulder belt 11 is tensioned along the direction of the arrow B by engaging the male buckle 32a of the shoulder belt 11 with the female buckle 32b, the load imparted to the waist touching portion 12 through the female buckle 32b can be dispersed to the back and forth of the female buckle 32b. Thereby, the concentration of the load on a local part of the waist touching portion 12 is prevented, then the waist touching portion 12 is pulled to the user 201 side evenly by the tension of the shoulder belt 11, thereby the waist touching portion 12 can be fit around the waist of the user 201 sufficiently. By fixing the back and forth of the female buckle 32b to the waist touching portion 12, there is an advantage that fastening direction of the female buckle 32b to the buckle fixing belting 33 can be fixed in an appropriate direction. When the male buckle 32a is mounted, there is no risk that the female buckle 32b turns to escape around the belt through portion 32c of the back end side, and there is an advantage that an attachment of the male buckle 32a becomes easy.

Return to FIG. 2 again, a male buckle 34a is attached to one of the waist belts 13 extended from the waist touching portion 12, and a female buckle 34b is attached to the other of the waist belts 13 respectively. An attaching position of the male buckle 34a is adjustable along the longitudinal direction of the waist belt 13. With waist touching portion 12 being touched around the waist of the user 201, by winding the waist belts 13 around the waist and by inserting the male buckle 34a into the female buckle 34b, the waist touching portion 12 can be attached to the waist of the user 201.

[About Horizontally-Carrying Seat]

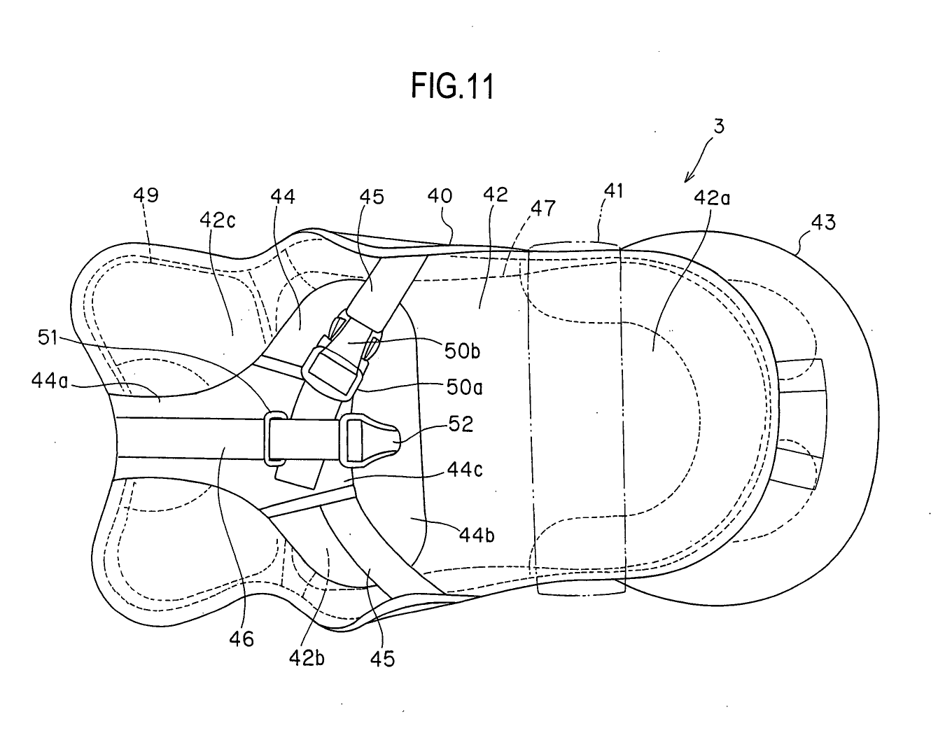

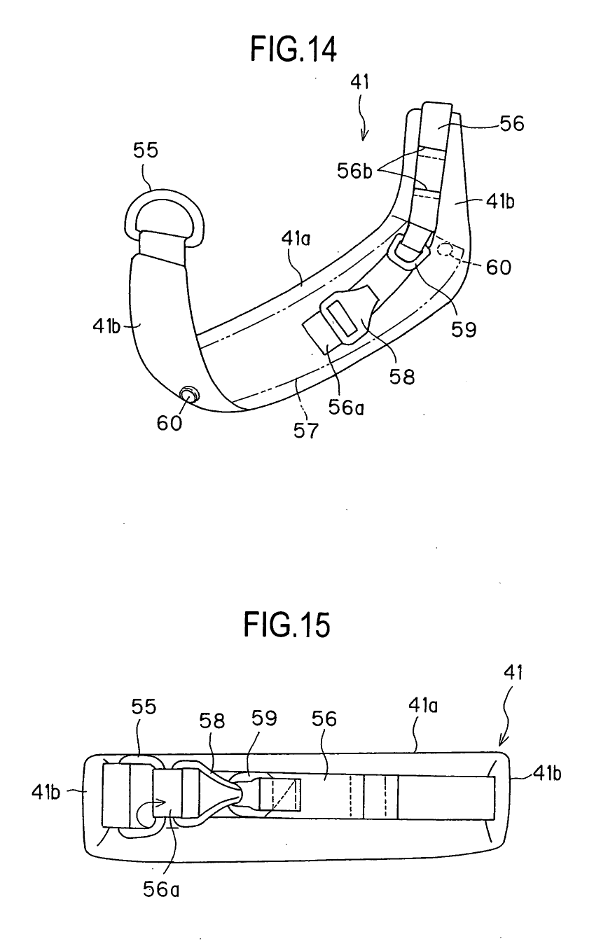

Next, the horizontally-carrying seat 3 will be descried. The horizontally-carrying seat 3 comprises a seat main body 40 shown FIG. 11 and a hanging board 41 shown in FIG. 14. The seat main body 40 comprises a mat 42 for laying the infant 200 in the lying down state, a head guard 43 arranged for surrounding the circumference of a head supporting portion 42a of the mat 42, an abdomen pad 44 provided to cover a buttocks supporting portion 42b of the mat 42, an abdomen belt 45 extending from both sides of buttocks supporting portion 42b and made to combine with the abdomen pad 44, and a buttocks belt 46 extending from a leg supporting portion 42c of the mat 42.

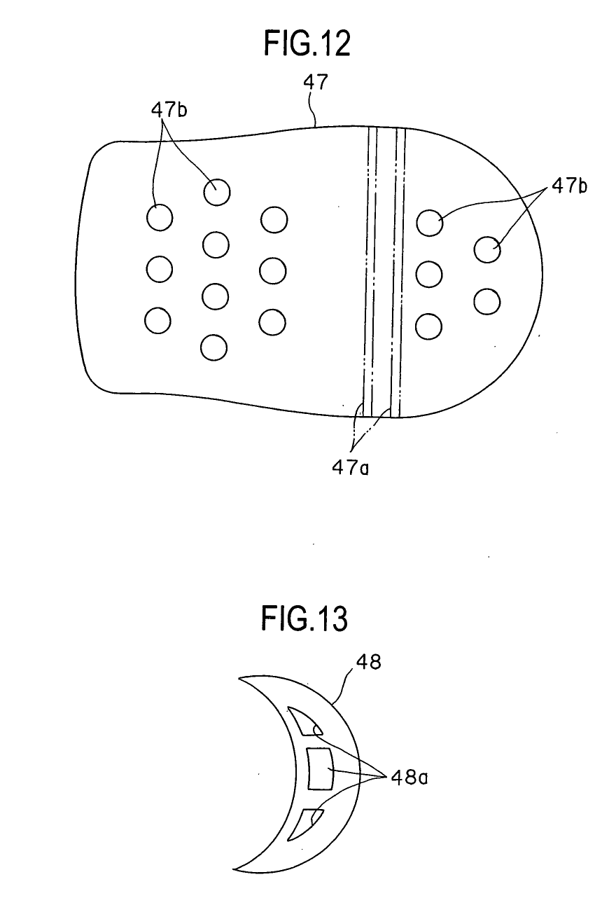

A back board 47 show in FIG. 12 is arranged inside of the mat 42. The back board 47 functions as a core material to keep the shape of the mat 42, and is a molding consisting of a hard resin material such as polypropylene resin as same as the back board 14 provided on the base portion 10 of the infant carrier main body 2. The rigidity of the back board 14 is determined so as to restrict the elastic deformation of the mat 42 occurred when the horizontally-carrying seat 3 is hung and supported and to maintain the shape of the mat 42 substantially uniform. A strengthening portion such as a rib can be appropriately provided on the back board 47 to increase the rigidity.

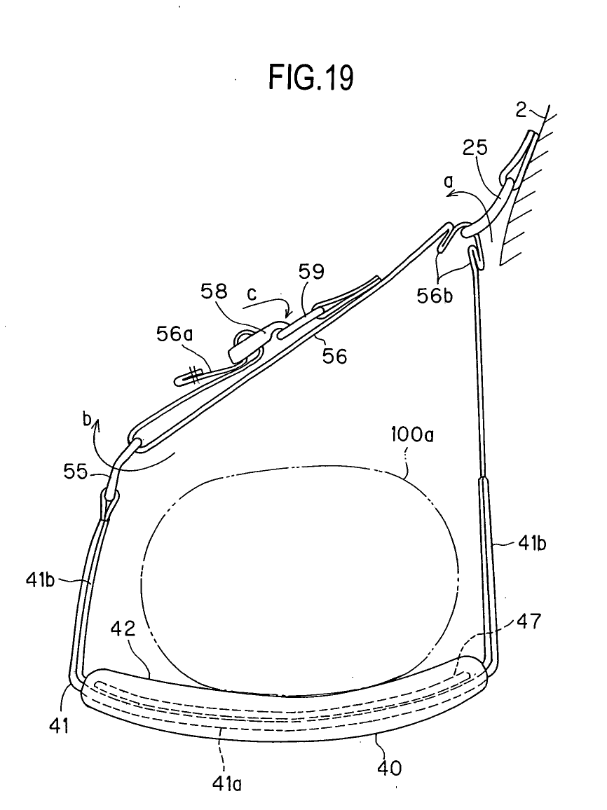

As shown in FIG. 11 in a chain double-dashed line, the hanging board 41 is mounted on the head supporting portion 42a so as to cross the inside of the mat 42 along the width direction, however, with regard to the top-and-bottom position relative to the back board 47, the hanging board 41 is arranged lower than the back board 47 (with reference to FIG. 19). Therefore, in the position where overlapping with the hanging board 41, it is preferable to provide a reinforcement rib 47a extending along the width direction of the mat 42.

There is provided a plurality of vent holes 47b . . . 47b to improve a permeability of the mat 42 on the back board 47. The back board 47 is covered with a face fabric. Various kinds of materials such as various cloths, three-dimensional mesh fabrics are used for the face fabric. There may be provided a cushioning material between the back board 47 and the face fabric appropriately. There is provided a core material 48 shown in FIG. 13 inside of the head guard 43. The core material 48 is a molding consisting a material such as foaming polyethylene resin which is a sufficiently soft compared to the back board 47. To improve the permeability of the head guard 43, a plurality of (three in the figure) vent holes 48a . . . 48a are formed on the core material 48. Three-dimensional mesh fabric is used for a face fabric of the head guard 43 which covering the core material 48 in consideration of a permeability.

As shown in FIG. 11 in a chain line, the back board 47 is provided from the attaching position of the head guard 43 to around the border between the buttocks supporting portion 42b and the leg supporting portion 42c. A seat board 49 constructed as a part different form the back board 47 is provided inside of the leg supporting portion 42c. The seat board 49 is also covered with a face fabric formed by hard resin as same as the back board 47. The mat 42 is foldable between the back board 47 and the seat board 49, in other words between the buttocks supporting portion 42b and the leg supporting portion 42c. So as to support legs of the infant 200 in the sufficient extent about the width direction (top-and-down direction of FIG. 11) of the mat 42, the seat board 49 projects in right-and-left direction of the width direction of the mat 42 from the back board 47 at the buttocks supporting portion 42b, and the seat board 49 is formed in an end-widening form which the width becomes grater as goes toward the foot of the infant 200.

The abdomen pad 44 comprises a crotch holding portion 44a and an abdomen holding portion 44b extending along the width direction of the mat 42 from the upper end of the crotch holding portion 44a. By sewing the lower end (the left end of FIG. 11) of the crotch holding portion 44a onto the mat 42, the abdomen pad 44 is attached to the mat 42 in the openable and closable state using the crotch holding portion 44a as an arm. There is provided a bag portion 44c opening to both sides of the width directions of the mat 42 on the upper end of the crotch holding portion 44a. One of abdomen belts 45 is made to be passed from one end side of the bag portion 44c and is drawn to the other end side. By engaging a male buckle 50a provided on one of the abdomen belts 45 with a female buckle 50b provided on the other of the abdomen belts 45, the abdomen belts 45 are joined each other. The attaching position of the female buckle 50b relative to the abdomen belt 45 is adjustable along the longitudinal direction of the abdomen belt 45.

The Buttocks belt 46 is arranged along the crotch holding portion 44a of the abdomen pad 44, and the end portion thereof is sewn on the mat 42 together with the crotch holding portion 44a. The buttocks belt 46 is arranged on the center about the width direction of the mat 42. A ring-like belt through tool 51 is attached to the surface of the bag portion 44c through which the abdomen belt 45 is passed. The buttocks belt 46 is made to be passed through the belt through tool 51 and drawn to the head guard 43 side, and a hook 52 is attached to the edge thereof. The hook 52 is used when the buttocks supporting portion 42b side is mounted on the infant carrier main body 2, however details are described later.

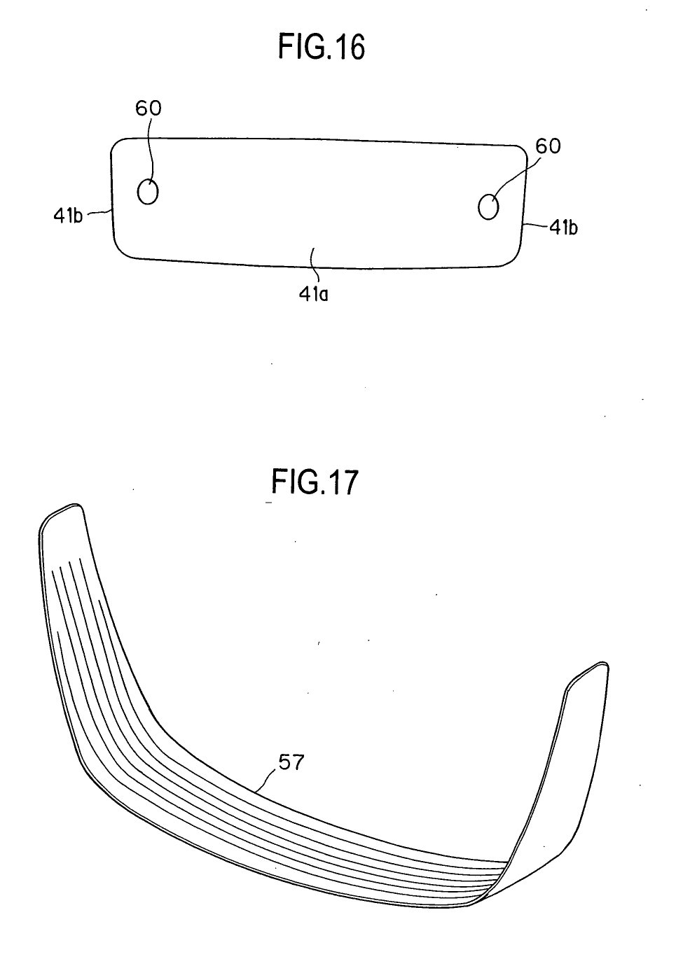

FIG. 14 is a perspective view, FIG. 15 is a plan view and FIG. 16 is a bottom view of the hanging board 41. As shown in these figures, the hanging board 41 comprises a pair of arm portions 41b, 41b projecting above from both ends of a belt-shaped mat receiving portion 41a. A fastening 55 is attached at the upper end of an arm portion 41b, a hanging belt 56 is attached at the upper end of the other arm portion 41b. A core material 57 shown in FIG. 16 is provided inside of the hanging board 41. The core material 57 is formed by a hard resin material such as nylon, polypropylene as same as the back board 14, and an appearance is substantially similar to the appearance of the hanging board 41. The core material 57 is covered by a face fabric consisting of various materials such as cloth or three-dimensional mesh fabric.

Return to FIG. 14 and FIG. 15, a hook 58 is attached at a distal end of the hanging belt 56, a fastening 59 enable to engaging with the hook 58 is attached in the middle of hanging belt 56. An excess length portion 56a of the hanging belt 56 produced by the positioning of the hook 58 is folded back form the hook 58 and arranged along the original of the hanging belt 56. The fastening 55 is of a size through which the hook 58 can be passed. This fastening 55 has a bending shape seen from the side as same as the fastening 25 mounted on the infant carrier main body 2 of FIG. 2. The bending direction is determined so as to bend to the outside about longitudinal direction of the mat receiving portion 41a of the hanging board 41 (with reference to FIG. 19).

The hanging board 41 is detachable to the seat main body 40. If the hanging board 41 is separated from the seat main body 40, it can be changed independently in the case if it is broken, and it can be washed independently in the case if it becomes dirty. In addition, there is another advantage that seat main body 40 is not bulky when it is carried. As shown in FIG. 16, a pair of snaps 60 is provided on the bottom face side of the hanging board 41. These snaps 60 are provided as means for preventing a displacement between the hanging board 41 and the mat 42 by engaging with snaps (not shown) of the mat 42 side when the hanging board 41 is mounted on the mat 2. In addition, on the mat 42 side, an opening (not shown) is provided, however, a direction of the hanging board 41 about the width direction of the mat 42 can be changed along a left-right direction. That is to say, the hanging board 41 can be attached to the mat 42 in either direction in which the fastening 55 is located in the upper side shown in FIG. 11 or located in the lower side shown in FIG. 11.

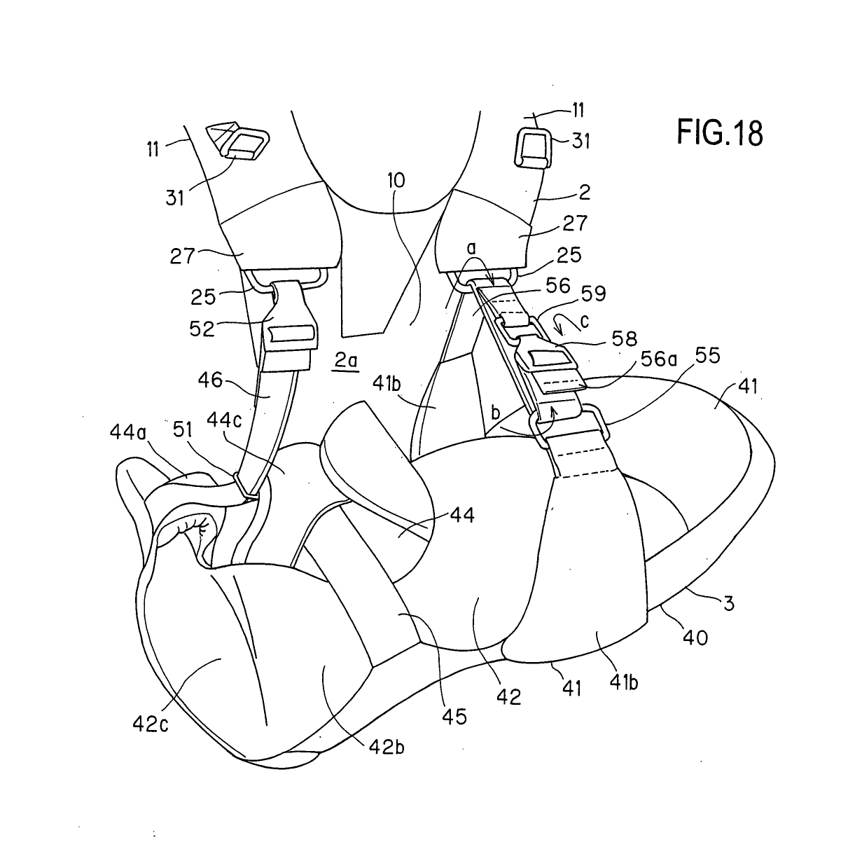

Next, how to use the horizontally-carrying seat 3 will be described. FIG. 18 shows the state in which the horizontally-carrying seat is mounted on the infant carrier main body, and FIG. 19 shows a state in which the hanging board 41 mounted on the seat main body 40 is mounted on the fastening 25. The hanging board 41 is mounted on the seat main body 40 in the direction in which the hanging belt 56 is located in the side close to the infant carrier main body 2. Therefore, when the head supporting portion 42a is directed to the left side of FIG. 18, the hanging board 41 is mounted on the seat main body 40 in the reverse direction along the longitudinal direction.

As shown in FIGS. 18 and 19 by arrows a, b and c, when hanging board 41 is mounted on the fastening 25, at first, the hook 58 of the hanging belt 56 is made to pass through the fastening 25 from inside, and then the hook 58 is made to pass through the fastening 59 of the hanging board 41 from the bottom, the hook 58 drawn above the fastening 59 is engaged with the fastening 59 of the hanging belt 56. Thereby, as shown in FIG. 19, a mat receiving portion 41a and arm portions 41b, 41b of the hanging board 41 and the hanging belt 56 are connected in loop-like, the hanging board 41 is hung to the fastening 25, and then the back board 47 is supported by the mat receiving portion 41a of the hanging board 41. As shown in FIG. 19, the head supporting portion 42a of the mat 42 is surrounded by the back board 47 made by a hard resin and the hanging board 41 in which a core material 57 made by a hard resin is embedded, therefore, deformation by the hanging load is restrict, enough space is provided around the head 200a of the infant, and the comfortableness is increased. Because the fastening 55 bends to the outside, an overhang of the fastening 55 or the hanging belt 56 to the head 200a side is restrain, therefore the comfortableness is further increased.

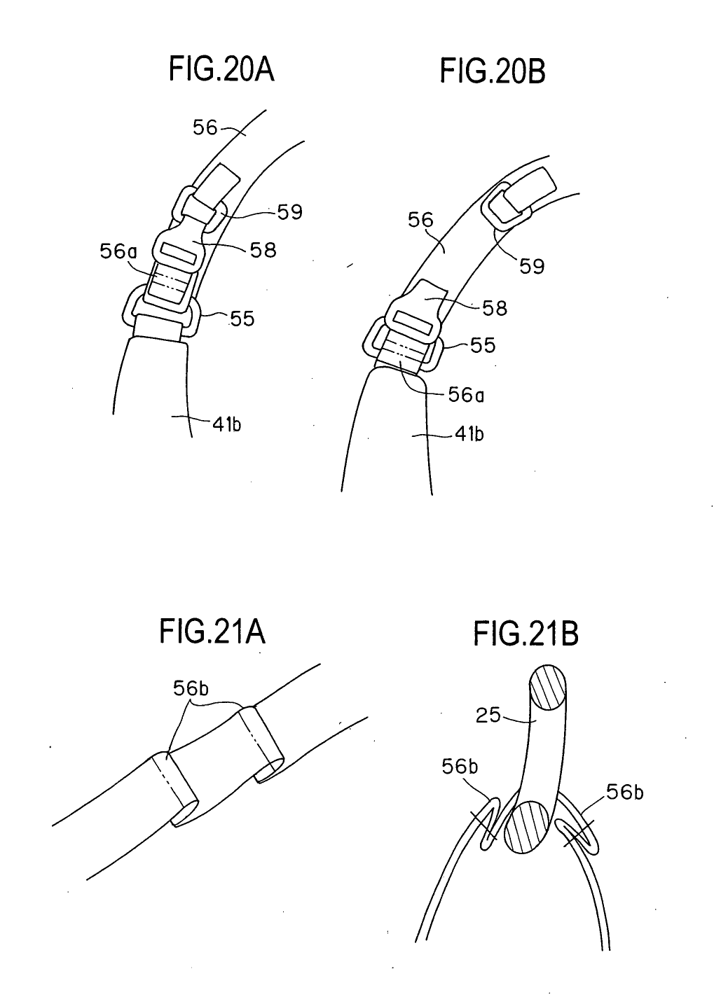

As shown in FIG. 20(a), in the state in which the hook 58 of the hanging belt 56 is engaged with fastening 59, the excess length portion 56a of the hanging belt 56 drawn from the hook 58 is folded back to the fastening side 55. Therefore, even if the hook 58 is fallen off from the fastening 59, as shown in FIG. 20(b), the excess length portion 56a is caught by the fastening 55, thus the hook 58 cannot pass through the fastening 55. Thereby, even if the hook 58 becomes unfastened, there is no risk that the hanging belt 56 is fallen off from the fastening 55 and a side of the hanging board 41 becomes free, thus the safeness is improved.

As shown in FIGS. 14, 19, and 21(a), in the middle of the hanging belt 56, by folding back the hanging belt 56 and sewing together, a pair of stopper portion 56b, 56b is formed. When making the hanging belt 56 to pass through the fastening 25 of the infant carrier main body 2, as shown in FIG. 21(b), by arranging stopper portions 56b, 56b at back and forth of the fastening 25, a slip of the hanging belt 56 relative to the fastening 25 can be restricted. Thereby, a change of relative position of each arm portions 41b, 41b of the hanging board 41 is restricted and the hanging state of the seat main body 40 from the fastening 25 can be keep almost constant.

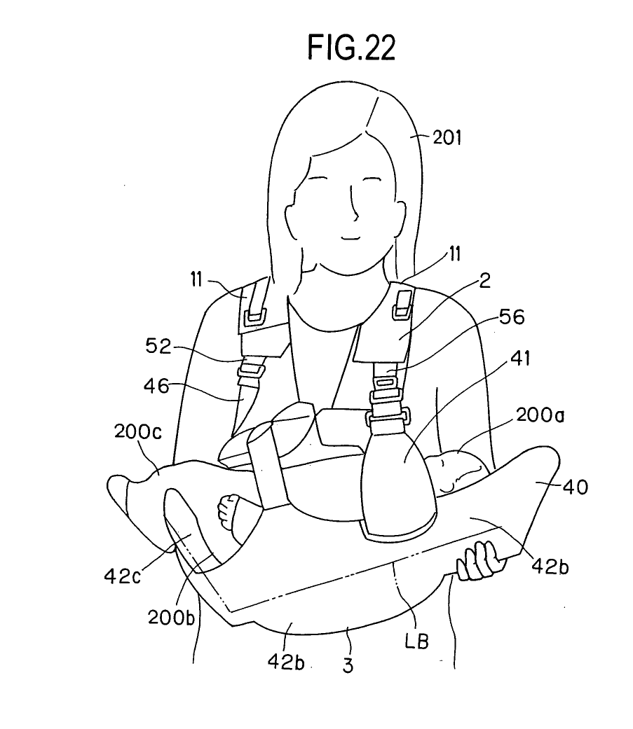

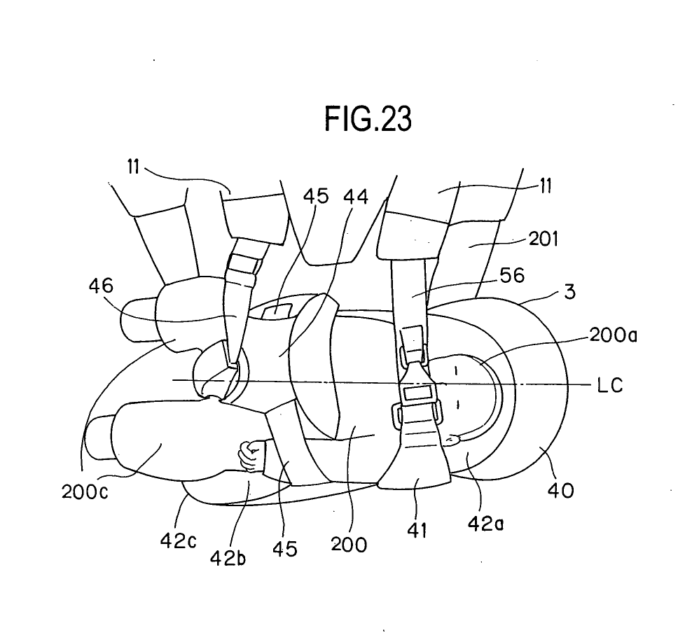

Return to FIG. 18, the buttocks supporting portion 42b side of the horizontally-carrying seat 3 is hung from and supported by the fastening 25 by engaging the hook 52 of the distal end of the buttocks belt 46 which passed through the belt through portion tool 51 with the fastening 25 of the opposite side of the infant carrier main body 2. In this hanging state, the crotch holding portion 44a of the abdomen pad 44 is folded, and the leg supporting portion 42c of the mat 42 is lifted from the buttocks supporting portion 42b to the obliquely upward. Therefore, as shown in FIG. 22, the leg portion 200c of the infant 200 is lifted higher than the buttocks 200b. In addition, the length of each belt 56, 46 are set so that the supporting position of the head supporting portion 42a by the hanging belt 56 is inclined to upper than the buttocks supporting portion 42b which supported by the buttocks belt 46. Therefore, as shown in FIG. 22 in a virtual line LB, a position of the infant 200 laid on the horizontally-carrying seat 3 falls from the head 200a toward the buttocks. 200b gradually, and the leg portion 200c is lifted upper than the buttocks 200b, thus a natural carrying position can be obtained. When the horizontally-carrying seat 3 is removed from the infant carrier main body 2, and it is put on the horizontal plane, such as the floor, the lifting of the leg supporting portion 42c by buttocks belt 46 is disappeared, and the area from the head supporting portion 42a to the leg supporting portion 42c it is maintained horizontally. Therefore, the infant 200 is not made to be laid in the unnatural position in which only the leg portion 200c is lifted.

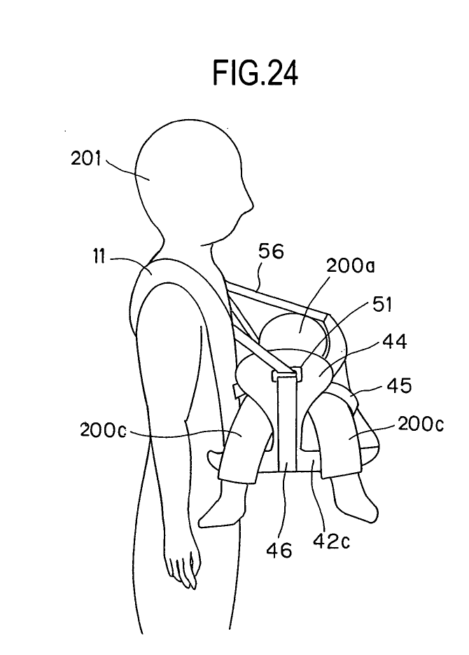

In above described horizontally-carrying state, the head supporting portion 42a is supported by the hanging belt 56 with the load dispersed at the both sides of the width direction. In addition, the buttocks supporting portion 42b and the leg supporting portion 42c are supported at the middle of the width direction of the leg supporting portion 42c by the buttocks belt 46, and are supported at the both ends of the width direction of the buttocks supporting portion 42c by the abdomen belt 45. Therefore, there is no risk that the mat 42 is twisted around the central line LC, thus the infant 200 laid to the mat 42 can be supported along the central line LC straightly. The back board 47 is bent by the weight of the infant 200 moderately with the central line LC being a bottom, therefore the infant 200 comes toward the central line LC of the mat 42, thus the vertically-carrying state becomes further stable. Further, as for the leg portion 200c, by arranging the wide seat 49, as shown in FIG. 24, enough space is provided around the leg portion 200c, then the compression of leg portion 200c can be prevented.

[About Vertically-Carrying Seat]

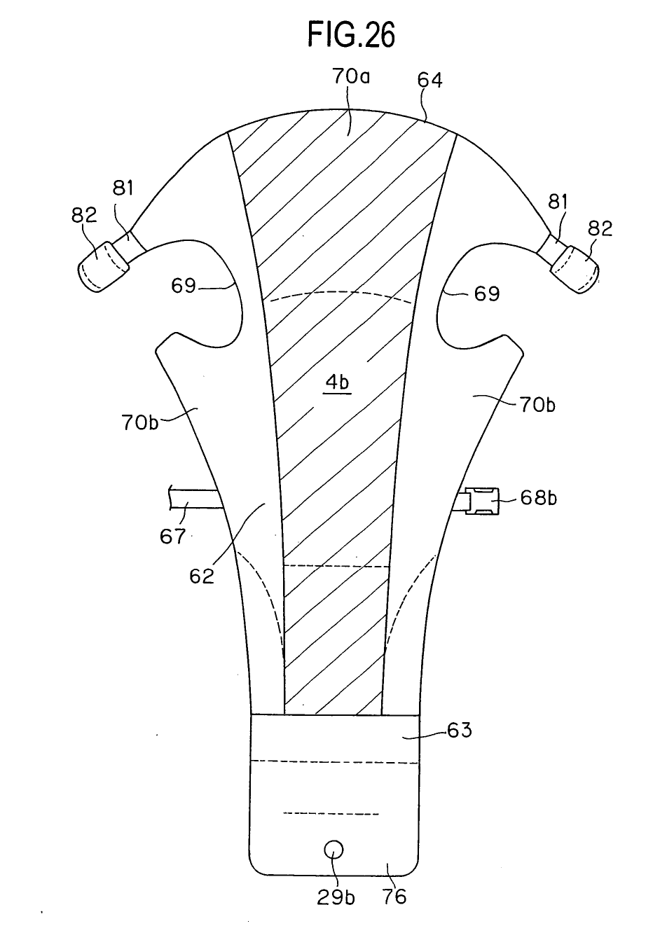

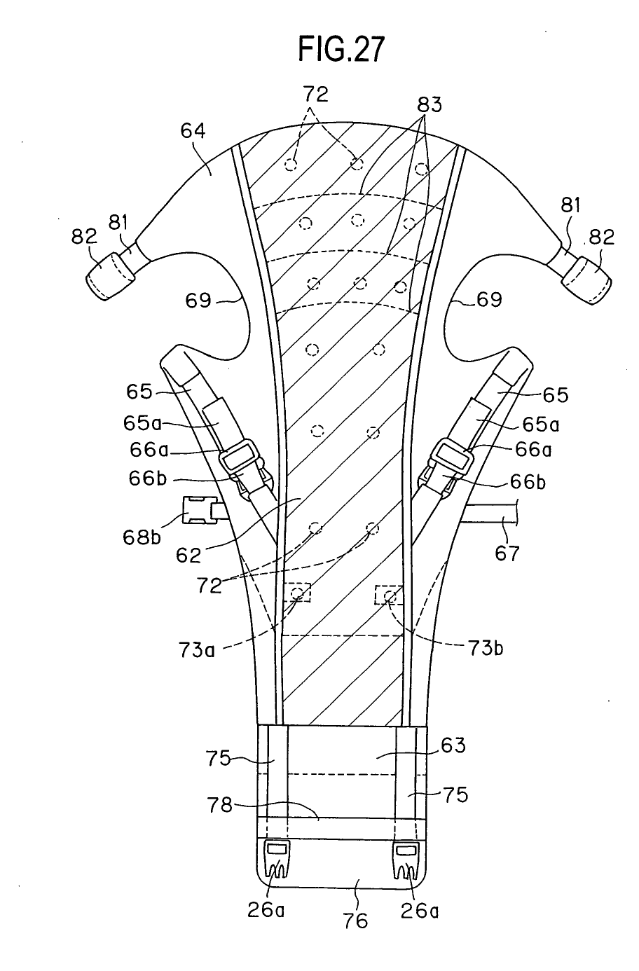

Next, a vertically-carrying seat 4 will be described. FIG. 25 is a view seeing the vertically-carrying seat 4 from the surface side 4a, and FIG. 26 is a view seeing from the back 4b side. FIG. 27 is a view shown a different aspect of surface 4a side of the vertically-carrying seat 4. The top-and-bottom direction of FIG. 25 and FIG. 26 corresponds to the top-and-bottom direction when it is used. The vertically-carrying seat 4 is used for forming a bag portion to accommodate the infant 200 vertically by attached it to the infant carrier main body 2 with the inner face 4b faced to the surface 2a of the infant carrier main body 2. As shown in these figures, the vertically-carrying seat 4 comprises a seat main body 62, a bottom supporting portion 63 provided continuously on the lower portion of the seat main body 62, a head support 64 provided continuously on the upper portion of the seat main body 62.

The seat main body 62 is a part to move the infant 200 toward the infant carrier main body 2 and to hold the infant 200, and underarm belts 65, 65 are extended from the both sides. Male buckles 66 are provided on the underarm belts 65, and female buckles 66b capable of engaging with each of the male buckles 66a are attached to the surface 4a side of seat main body 62. By engaging the right-and-left male buckles 66a with the female buckles 66b respectively, as shown in FIG. 27, loops by the underarm belts 65 can be formed in the right-and-left side of the seat main body 62. The male buckles 66a are adjustable in length along the longitudinal direction of the underarm belt 65. The excess length portions 65a of the underarm belts 65 drawn from the male buckles 66a are folded back to the base sides (joining portions with seat main body 62) of the underarm belts 65 from the male buckles 66a as same as the excess length portion 65a of the hanging belt 56. In addition, a body belt 67 mounted around the waist of the infant 200 is extended from one side of the seat main body 62. A male buckle 68a is provided at the distal end of the body belt 67 with its position being adjustable, and the male buckle 68a capable of engaging with a female buckle 68b is provided opposite side of the seat main body 62.

Arm through portions 69 to make the arm of the infant 200 passed through are formed between the seat main body 62 and the head support 64. In addition, the closer to the bottom supporting portion 63, the narrower the width of the seat main body 62 becomes. The vertically-carrying seat 4 does not comprise a core material having a high rigidity such as the back board 14 of the infant carrier main body 2, the back board 47 or the seating board 49 of the horizontally-carrying seat 3, and only a core material consisting of a soft material such as urethane form is arranged inside, if necessary. To improve a permeability of the vertically-carrying seat 4, the hatched area 70a FIG. 26 is formed by a three dimension mesh fabric. Area 70b positioned outside of the hatching area 70a is constructed by covering above-described core material with a suitable face fabric. The surface fabric of the surface 4a may be different from or identical to that of the back side 4b. In addition, in the area 70a, it may be provided an inner packing material such as a core material of a cushioning material appropriately, however in that case, as shown in FIG. 27 in a broken line, it is desirable to provide vent holes 72 . . . 72 on the inner packing material. In addition, in the area 70a from the lower part of the seat main body 62 to the bottom supporting portion 63, the inner packaging material such as a core material or a cushioning material is not provided, and it is possible to shorten the vertically-carrying seat 4 along the width direction from the shown state. A pair of snap 73a, 73b is provided on the surface side of the seat main body 62 spaced along the width direction so as to be covered by the three-dimensional mesh fabric. By engaging these snaps 73a, 73b, it is possible to keep the state in which the width of the lower part of the seat main body 62 is narrowed. When the infant is carried in a forward-looking state, by narrowing the width in this way, the crotch part of the infant is released sufficiently and the amenity can be improved.

The bottom supporting portion 63 is provided for forming a bottom portion of the bag-like portion to hold the infant by being combined with the infant carrier main body 2. As shown in FIGS. 25 and 27, a pair of right-and-left adjust belt 75, 75 is provided on the bottom supporting portion 63. Male buckles 26a are attached to the distal end of each adjust belt 75. Each male buckle 26a can engage with the female buckle 26b of the infant carrier main body 2. Attaching positions of the male buckle 26a relative to the adjust belt 75 is adjustable to the longitudinal direction of the adjust belt 75.

Furthermore, a flap 76 is provided on the bottom supporting portion 63 for covering the male buckle 26a, and snap 29b is provided on the flap 76. The snap 29b is capable of engaging with a snap 29a of the infant carrier main body 2 (with referrer to FIG. 2). In addition, a loop belt 78 for making the adjust belt 75 to pass through is provided on the flap 76. The Male buckles 26a can be passed through this loop belt 78 and can be drawn to the lower end side of the vertically-carrying seat 4.

The head support 64 is provided for protecting the head portion 200a of the infant 200. As shown in FIG. 25, support belts 80 are extended from both sides of the head support 64, hooks 81 are attached to the distal end side of those support belts 80. The hooks 81 can engage with the supporting fastening 31 of the infant carrier main body 2. The hooks 81 are attached to the back side 4b of the support belt 80. That is to say, the hooks 81 are attached to the support belts 80 in a back and forward reversed condition, when the hooks 81 are latched to the supporting fastenings 31, the support belts 80 need to be twisted. The reason will be descried later. As shown in FIGS. 26 and 27, head hook covers 82 are provided on the support belts 80 to cover the hooks 81. In FIG. 25, the head hook covers 82 are not shown. The head hook covers 82 are provided so that the hooks 81 are not touched to the face of the infant 200. For convenience for such as cleaning, the hook coves 82 can be pulled off from the support belts 80.

Further, the head support 64 is partitioned by three seam line 83 which are separated in the top-and-bottom direction. Because the core material is divided by each of the seamed lines 83, the head support 64 is foldable toward the outside (the side of the surface 4a) by making either of the seamed lines 83 as a border.

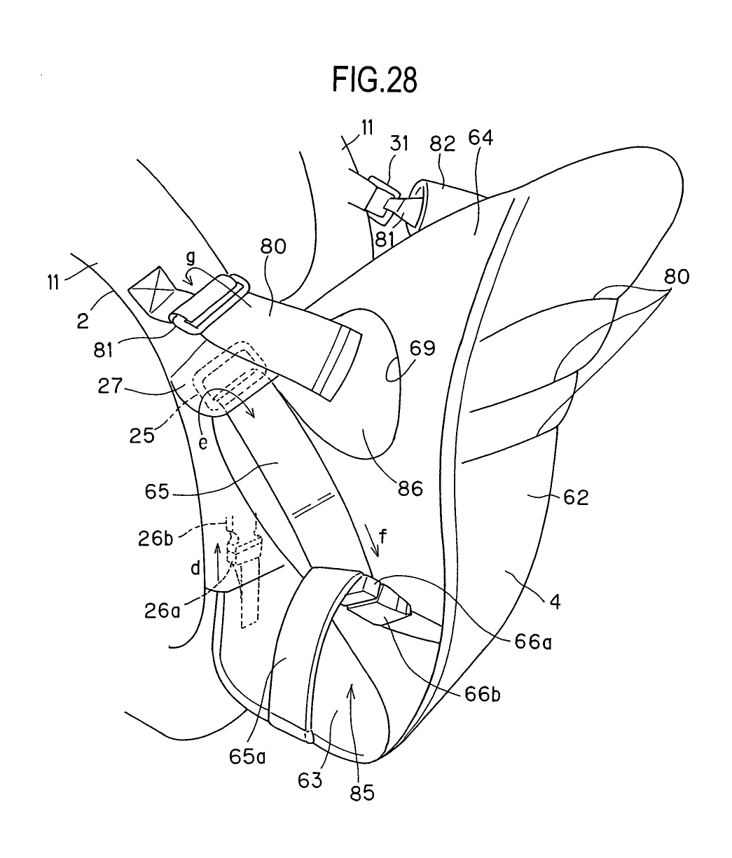

Newt, how to use the vertically-carrying seat 4 will be described. FIG. 28 shows the state in which the vertically-carrying seat 4 is mounted on the infant carrier main body 2. As shown in this figure, for attaching the vertically-carrying seat 4 to the infant carrier main body 2, in the state which the vertically-carrying seat 4 is reversed as shown in the arrow d, mounting each of the male buckles 26a of bottom supporting portion 63 to the female buckles 26b of the infant carrier main body 2, and engaging snaps 29a, 29b each other, then joining the infant carrier main body 2 and the bottom supporting portion 63 of the vertically-carrying seat 4. After it has been joined, the vertically-carrying seat 4 is folded back, and a loop to support portion 63 is formed. In addition, about the underarm belt 65 as shown in the arrow e, the male buckle 66a is passed through the fastening 25 from the backside, and the underarm belt 65 is drawn to the front side of the fastening 25. As shown in the arrow f, the male buckle 66a is mounted on the female buckle 66b which is fixed to the vertically-carrying seat 4, and then a loop by the underarm belt 65 is formed. Furthermore, the hooks 81 of the support belt 80 extending from the head support 64 is hooked form the outside relative to the supporting fastening 31 as shown in the arrow g. Because above procedure is taken, as shown in FIG. 28, the vertically-carrying seat 4 is fixed to the infant carrier main body 2, and a pocket to accommodate the infant 200 therebetween is formed. In addition, because the excess length portion 65a of the underarm belt 65 is folded back from the male buckle 66a, even if the male buckle 66a is fallen off from the female buckle 66b, the excess length portion 65a is caught on the fastening 25, thus the male buckle 66a cannot pass through the fastening 25. Therefore, the safeness is ensured. This point is the same as the relation between the hanging belt 56 and the fastening 25.

In the state of FIG. 28, the buttocks of the infant is mounted on the bottom of the loop formed by the bottom supporting portion 63, leg portions of the infant are projected to the outside of the vertically-carrying seat 4 from the crotch-passing aperture 85 produced on the sides of the bottom supporting portion 63. In addition, arms of the infant are projected to the outside of the vertically-carrying seat 4 from the apertures which produced on the part of the arm through portion 69, and the underarm belts 65 are passed through under the arms of the infant.

Above-described fixing manner is a basic manner which is common to face-to-face carrying state the forward-looking carrying state and the backing carrying state using the vertically-carrying seat 4, however in the infant carrier 1 of this embodiment, by using alignment function of each portion of the vertically-carrying seat 4, various using manner will be realized. In the followings, these will be descried.

[About Depth Adjustment of Vertically-Carrying Seat]

In the infant carrier 1 according to this embodiment, by changing the attaching position of the male buckles 26a relative to the adjust belts 75, the depth of the bottom supporting portion 63 of the vertically-carrying seat 4, in other words, the supporting position of the buttocks of the infant by the bottom supporting portion 63 can be changed along the top-and-bottom direction. That is, if the adjust belts 75 are shortened, the depth of the bottom supporting portion 63 can be decreased, if the adjust belts 75 are lengthened, the depth of the bottom supporting portion 63 can be increased. FIG. 29 shows a joining procedure between the bottom supporting portion 63 and the infant carrier main body 2, when the adjust belts 75 are shortened, and FIG. 30 shows a joining procedure between the bottom supporting portion 63 and the infant carrier main body 2 when the adjust belts 75 are lengthened.

That is, to make bottom supporting portion 63 shallow, as shown in FIG. 29(a), by changing fixing position of the male buckles 26a to the base side (the sewn position for the bottom supporting portion 63) of the adjust belts 75 while the adjust belts 75 being passed through the loop belt 78, the adjust belts 75 are shortened and the bottom supporting portion 63 is folded partially. In this state, as shown in FIG. 29(a), the male buckles 26a are inserted into the female buckles 26b of the infant carrier main body 2 and snaps 29a and 29b are engaged.

On the other hand, to make the bottom supporting portion 63 deep, as shown in FIG. 30(a), by changing attaching position of the male buckles 26a to the distal end side of the adjust belts 75 while the adjust belts 75 being passed through the loop belt 78, the adjust belts 75 are lengthened and the bottom supporting portion 63 is straightened. In this state, as shown in FIG. 30(b), the lower end portion of the bottom supporting portion 63 including male buckles 26a is passing through the swing-preventing band 30 of the infant carrier main body 2 (with reference to FIG. 2), and after that, as shown in FIG. 30(c), the male buckles 26a are inserted into the female buckles 26b of the infant carrier main body 2, then the snaps 29a, 29b are engaged. In this way, if the depth of the bottom supporting portion 63 is adjusted, in the front-carrying state or the back-carrying state utilizing the vertically-carrying seat 4, the bottom supporting portion 63 can be rounded in the loop-like in the optimum depth depending on a physique of the infant. In addition, when the depth is especially increased, by making the bottom supporting portion 63 to pass through the swing-preventing band 30, there is an advantage that the swing of the bottom supporting portion 63 can be prevented. That is, when the depth of the bottom supporting portion 63 is made to be increased, the bottom of the loop formed by the bottom supporting portion 63 is far apart under the joining position of the buckles 26a, 26b, even though the bottom supporting portion 63 is restricted at the joining position of buckles 26a, 26b, the back and forth and right-and-left swing of the infant supported by the bottom supporting portion 63 can not be restrained sufficiently. While, by using the swing-preventing band 30 at the position lower than the female buckle 26b, the bottom supporting portion 63 is restricted in the back and forth and the right-and-left direction, the swing of the buttocks of the infant supported by the bottom supporting portion 63 can be restrained.

According to the joining structure described above, because the bottom supporting portion 63 is joined with the infant carrier main body 2 by two sets of buckles 26a, 26b, even if one set of buckles 26a, 26b fall off, the state which the bottom supporting portion 63 is joined with the infant carrier main body 2 is maintained, thus high safeness can be obtained. In addition, because the buckles 26a, 26b are arranged in a position higher than the loop formed by the bottom supporting portion 63, by putting a cushioning material in the loop-shaped portion of the bottom supporting portion 63, the feel when the infant use it can be improved.

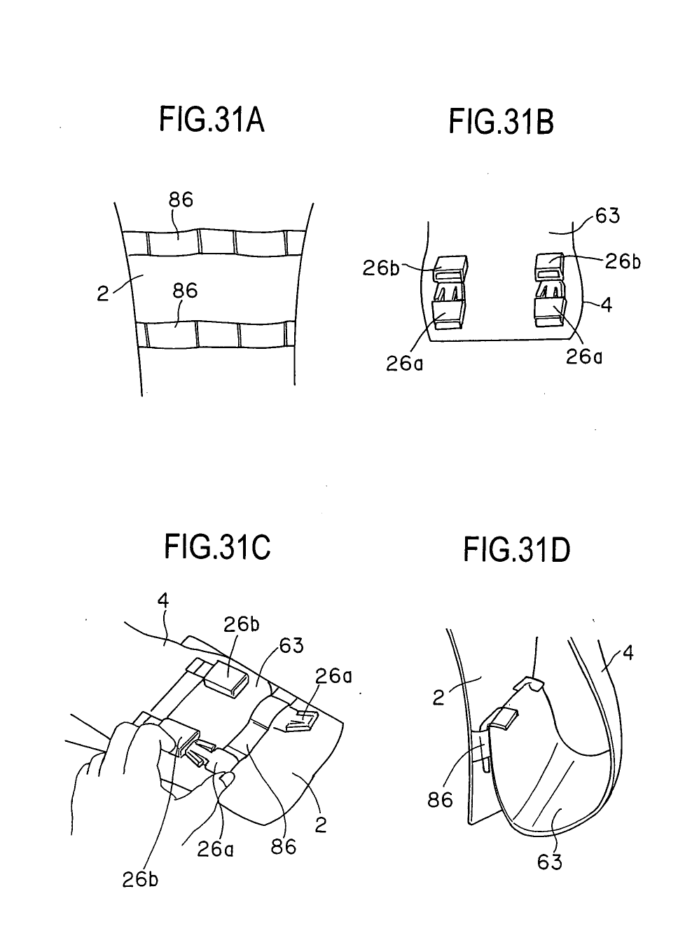

An adjustment of the supporting position by the bottom supporting portion 63 can not be limited to above-described above configuration, and it can be realized by the other configuration. FIG. 31(a) . . . (d) shows an example. In this example, loop bands 86 are attached to the infant carrier main body 2 in two-tired (FIG. 31(a)), and the male buckles 26a and the female buckles 26b are attached to the bottom supporting portion 63 of the vertically-carrying seat 4 (FIG. 31(b)). When the bottom supporting portion 63 is joined to the infant carrier main body 2, either of upper or lower bottom loop bands 86 is chosen, the male buckles 26a are made to pass through the chosen loop band 86, then they are joined with the female buckles 26b, (FIG. 31(c)), after that the bottom supporting portion 63 is folded back as a loop-like (FIG. 31(d)). Thereby, the joining position of the bottom supporting portion 63 can be changed in either of two-tiered top-and-bottom positions.

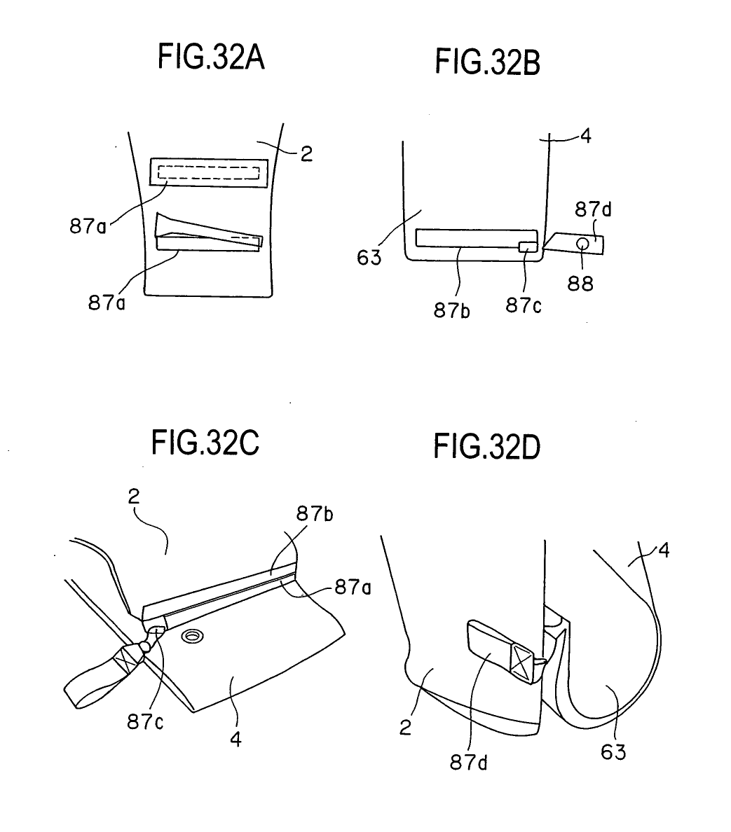

FIG. 32(a) to (d) shows other example. In this example, fasteners 87a are attached to the infant carrier main body 2, at the two-tiered positions (FIG. 32(a)), and fastener 87b enable to engaging with the fasteners 87a is attached (FIG. 32(b)) to the bottom supporting portion 63 of the vertically-carrying seat 4. When the bottom supporting portion 63 is joined to the infant carrier main body 2, either one of top-and-bottom of the fasteners 87a on the infant carrier main body 2 side is chosen, and the chosen fastener 87a and the fastener 87b of the bottom supporting portion 63 are aligned and a chuck 87c is pulled, then both are engaged (FIG. 32(c)). After that, the bottom supporting portion 63 is folded back as a loop-like, a handle 87d of a clamp 87c is fixed to the back side of the infant carrier main body 2 using the snap 88 (FIG. 32(d)). By such a structure, the joining position of the bottom supporting portion 63 can be changed either one of two-tiered positions.

[About Folding Back of Head Support]

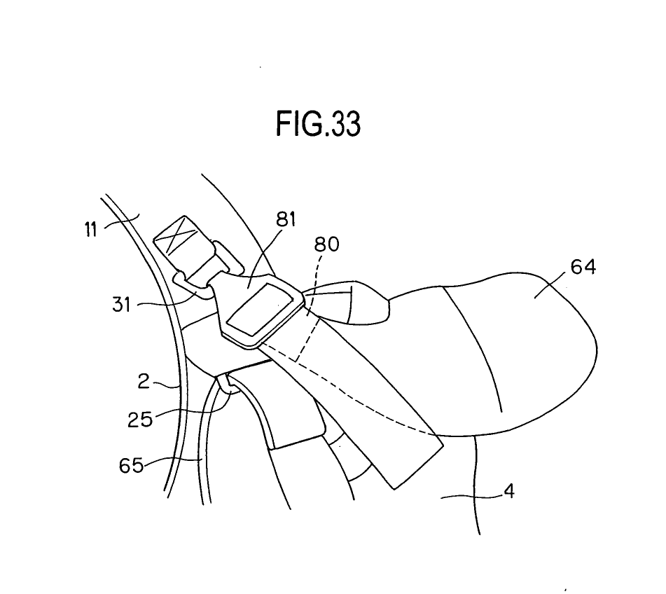

As already descried in FIG. 1, in the infant carrier 1 according to this embodiment, when the vertically-carrying seat 4 is used, by the head support 64 thereof being folded back along either one of three seam lines 83 outwardly (with reference to FIGS. 25, 27 and 28), it can be used in different style. An example of the folded back state is shown in FIG. 33. As described above, in this embodiment the hook 81 of the support belt 80 is attached in a state in which the back side and the front side are reversed, and the support belt 80 is half-turned so that the back side becomes front, then the hook 81 is attached to the supporting fastening 31. Therefore, if the support belt 80 is half-turned to the direction reverse to the twisting direction to be generated when the head support 64 is folded back to the support belt 80 beforehand and latched the hook 81 to the fastening 31, it is expected that twist of support belt 80 is dissolved when the head support 64 is folded back, and the head support 64 can be folded back with the hook 81 being hooked to the fastening 31.

As is clear from FIG. 1(d) and FIG. 1(f), when the head support 64 is folded back at a maximum, depending on position of the arm of the infant 200, the support belt 80 sometimes becomes obstacle, in that case, the support belt 80 may be passed through under the arm of the infant 200 and then the hook 81 may be attached to the fastening 31.

[About Advantages of Infant Carrier Main Body]

Next, an advantage of the infant carrier main body 2 will be described. At first, in this embodiment, because the back board 14 made by hard resin is embedded in the infant carrier main body 2, the load acting on the infant carrier main body 2 can be dispersed to the shoulder belt 11 and waist touching portion 12. Therefore, the burden to the user can be reduced. In the case when the back board 14 is omitted and only the cushioning material is embedded in the infant carrier main body 2, the infant carrier main body 2 greatly deforms by the weight of the infant, and the load is inclined to the shoulder or the waist of the user.

In addition, in this embodiment, because the folding portion 17 is provided at the lower part of the back board 14, the waist touching portion 12 is bendable relative to the base portion 10, therefore, when the infant is carried on the user's back from the state in which the infant is made to sit on the sitting surface such as a sofa, because the waist touching portion 12 escapes moderately, there is an advantage that the existence of the back board 14 is not become obstacle even if lower part of infant carrier main body 2 contacts the sitting surface.

On the other hand, because a rigid body such as the back board 14 is not embedded in the vertically-carrying seat 4, the infant held in the vertically-carrying seat 4 becomes to be pulled up from under underarm by the underarm belt 65. Therefore the vertically-carrying seat 4 is easy to fit to the physique of the infant, and the degree of adhesiveness between the user and the infant can be increased. Thereby, the load dispersion to the shoulder or the waist of the user is ensured, thus the burden to the user can be reduced.

As described above, the shoulder belt 11 of the infant carrier main body 2 can be used in both of the cross-hanging state or the ruck-hanging state, however, the cross-hanging state is used mainly when the infant is carried in front of the user, and the ruck-hanging state is used when the infant is carried the back of the user. When it is used in such a dual-purpose, if the position of the waist touching portion 12 is unchangeable, the waist touching portion 12 rises to the vicinity of the chest of the user in the backing-carrying state, as the result, the infant departs from the user, and the backing carrying position sometimes fall down more than required, then the weight of the infant can not be dispersed adequately around the waist of the user. To the contrary, the infant carrier main body 2 of this embodiment can change the position of the waist touching portion 12 relative to the base portion 10 along the top-and-bottom direction. Therefore, the waist touching portion 12 is lowered when it is used for the back-carrying, and it is raised when it is used for the front carrying, for either of the back-carrying state or the front carrying state, the length of the top-and-bottom direction of the infant carrier main body 2 can be optimized. Thereby, the lowering of the position of the back carrying of the infant as described above can be prevented, and the load is dispersed to the shoulder and the waist of the user in either position, then the burden to the user can be reduced.

In the above-described embodiment, the fastening 25 corresponds to the body side fastening, the fastening 55 corresponds to the board side fastening, and the fastening 59 corresponds to the belt side fastening respectively. The present invention is not limited within the above embodiment, but it may be implemented in other various embodiments. For example, in the first aspect of the present invention, the back board 47 does not be required to be provided on the seat main body 40. The joining between the hanging board 41 and the infant carrier main body 2 is not limited to the shown example, but it may be conducted in various methods. The vertically-carrying seat 4 is not indispensable for the first aspect of the present invention. In the first aspect of the present invention, the infant carrier main body 2 may be constructed as premises for the combination with the horizontally-carrying seat 3. In the first aspect of the present invention, as far as the hanging board comprises a core material consisting of a hard material, it is not always necessary for a core material to be covered in the face fabric. For example, the hanging belt and the fastening may be attached directly to both ends of the core material made by the hard resin. In brief, as far as the core material functions as a core to impart rigidity, it does not need to be embedded in some articles.

In the infant carrier of the second aspect of the present invention, the fixed position of the infant carrier main body for the user is not limited around the shoulder or around the waist but it may be fastened at other points. The folding portion of the back board does not need to be foldable around a shank material such as hinge axis, but a folding axis can be made by making thin parts on the resin molding partially. In the second aspect of the present invention, the horizontally-carrying seat is not indispensable, and the second aspect of the present invention can be applied for the infant carrier using only the vertically-carrying seat.

In the above-described embodiment, the joining structure shown in FIG. 29 and FIG. 30 corresponds to the infant carrier of the third aspect of the present invention. The female buckle 26b correspond to the sheet fasting part, the male buckle 26a corresponds to a joining tool respectively. In addition, the joining structure shown in FIG. 31 and FIG. 32 corresponds to the fourth aspect of the present invention. In FIG. 31, loop bands 86 corresponds to the sheet fastening, the buckles 26a, 26b correspond to the joining tools respectively, in FIG. 32, fasteners 87a corresponds to the sheet fastening, and fastener 87b corresponds to the joining tool respectively. In these aspect, the sheet fastening portion and the joining tools are not limited to the example which a buckle and a fastener is used, as far as having the strength capable of supporting the infant, various means can be used.

In the fifth aspect of the present invention, it is not limited to configuration in which both of the base portion and the waist touching portion can be relatively displaced on the connecting portion therebetween, but the distance between the shoulder belt side and the waist touching portion of the base portion can be made to be changed by providing the length-adjustable portion at the base portion. The Horizontally-carrying seat is not indispensable for the fifth aspect of the present invention and the fifth aspect of the present invention can be applied to the infant carrier using only the vertically-carrying seat.

In above-described embodiment, the hanging board 41 (including fastening 56 and hanging belt 56) corresponds to the head side hang tool, the abdomen pad 44 (including the belt through portion tool 51), the abdomen belt 45 and the buttocks belt 46 corresponds to the buttocks side hangs tool respectively. The features about the horizontally-carrying seat of the present invention can be applied to the infant carrier for the horizontally-carrying exclusive use having no vertically-carrying seat. On the contrary, the features about the vertically-carrying seat of the present invention can be applied for the infant carrier for vertically-carrying exclusive use having no horizontally-carrying seat.

In above-described embodiment, the shoulder belt 11 corresponds to the belt-shaped object, the waist touching portion 12 corresponds to the fixed portion, the male buckle 32a attached to the shoulder belt 11 corresponds to on of the buckle, and the female buckle 32b fixed to the waist touching portion 12 corresponds to the other buckle or the fixing side buckle respectively. However, the male buckle may be attached to the waist touching portion. The joining structure of the present invention is not limited to the joining portion between the shoulder belt and the waist touching portion of the infant carrier, but it can be applied to various joining structure in which the male buckle and the female buckle are used.

### Second Embodiment

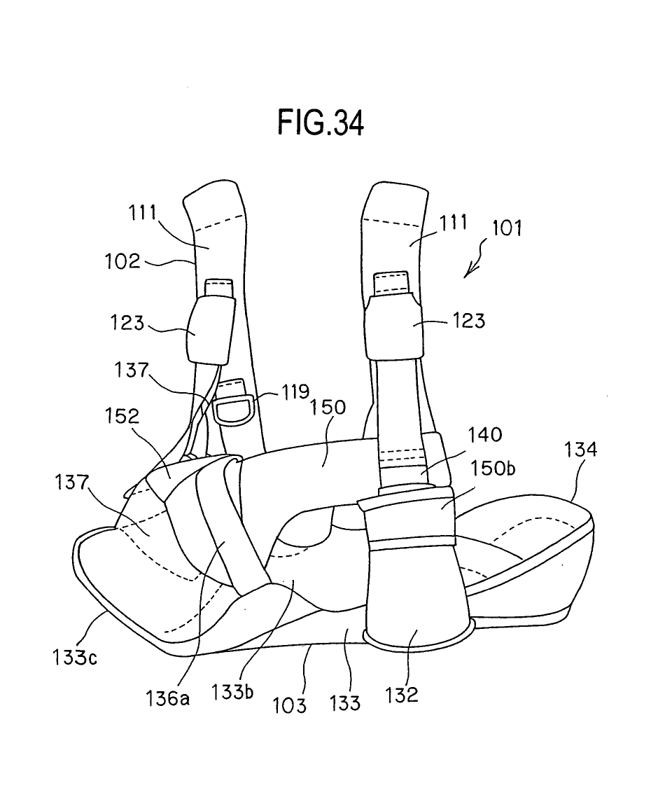

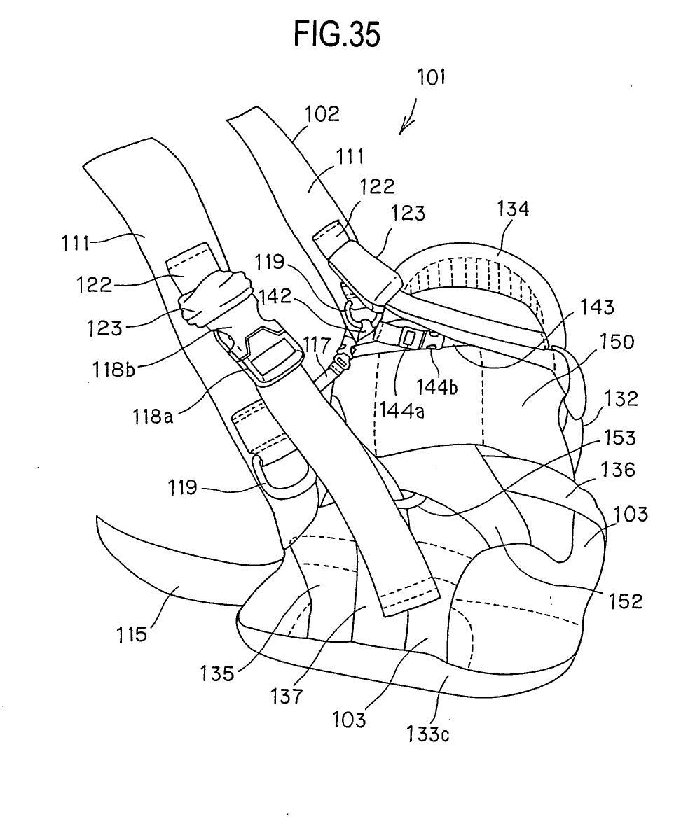

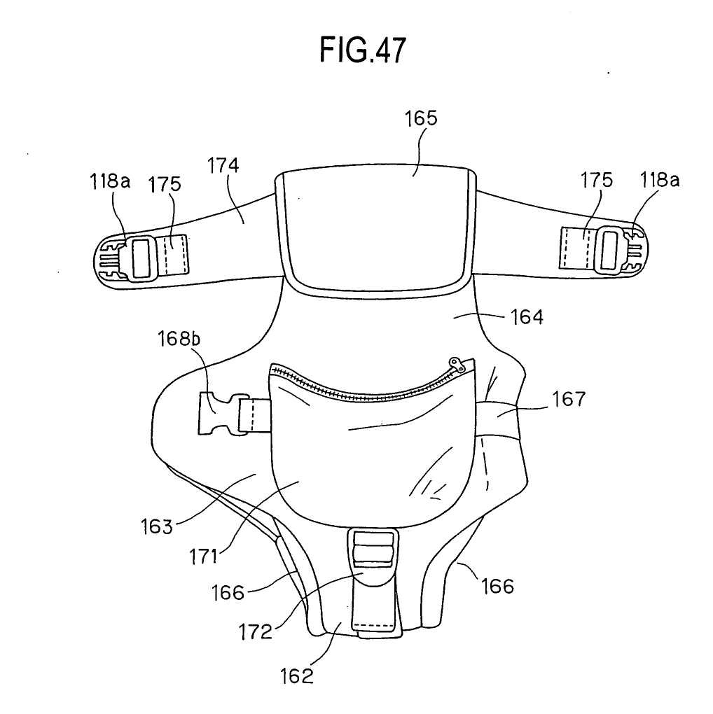

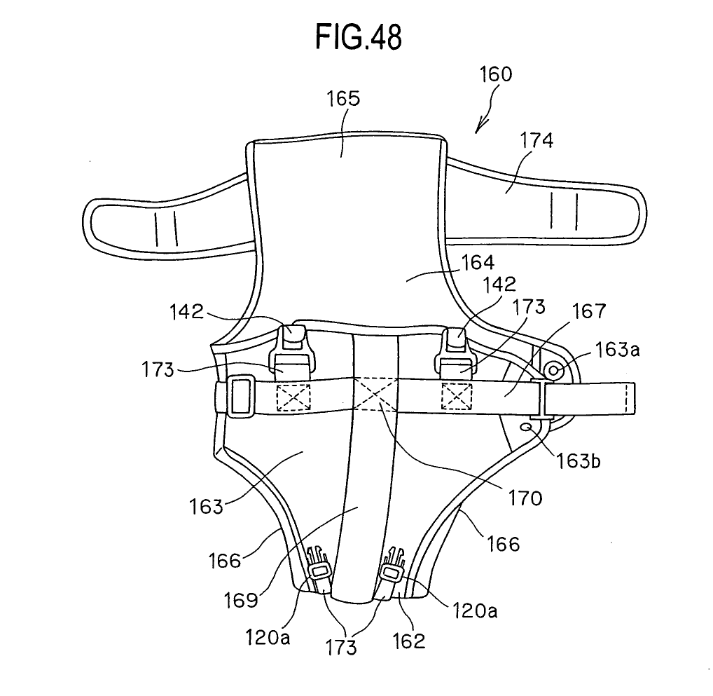

Hereinafter, the second preferred embodiment of the infant carrier which the present invention is applied to will be described. FIG. 34 and FIG. 35 show an infant carrier according to the second embodiment of the present invention. An infant carrier 101 comprises an infant carrier main body 102 which a user (for example, parents) put on and a horizontally-carrying seat 103 mounted on the infant carrier main body 102. In the followings, these will be described sequentially. To the infant carrier main body 102, instead of the horizontally-carrying seat 103, a vertically-carrying seat shown in FIG. 47 and FIG. 48 can be mounted, however this point will be described later.

[About Infant Carrier Main Body]

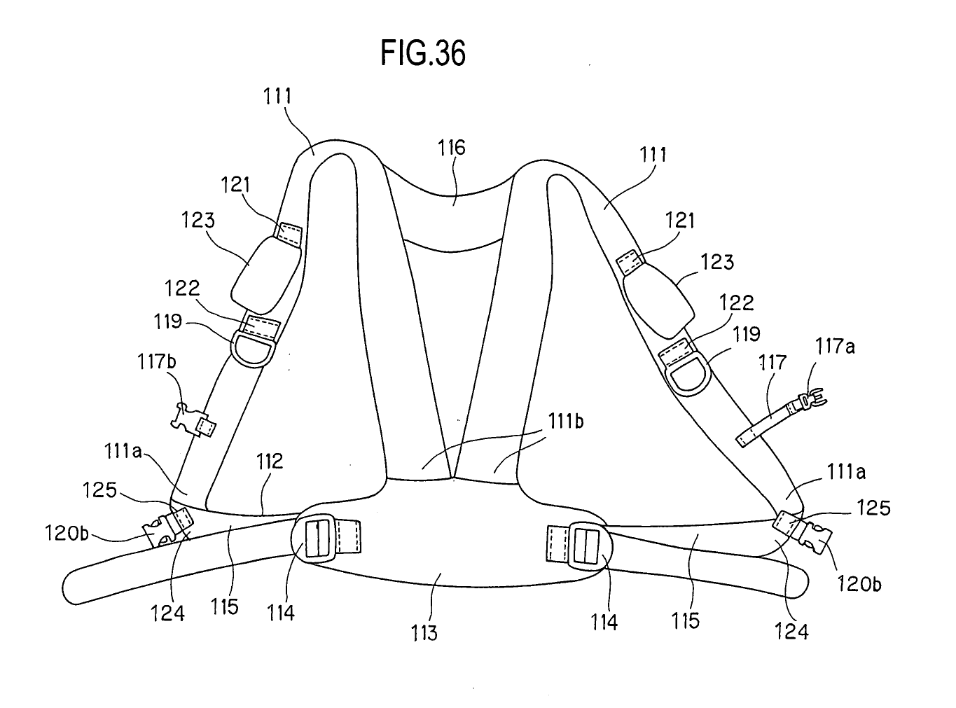

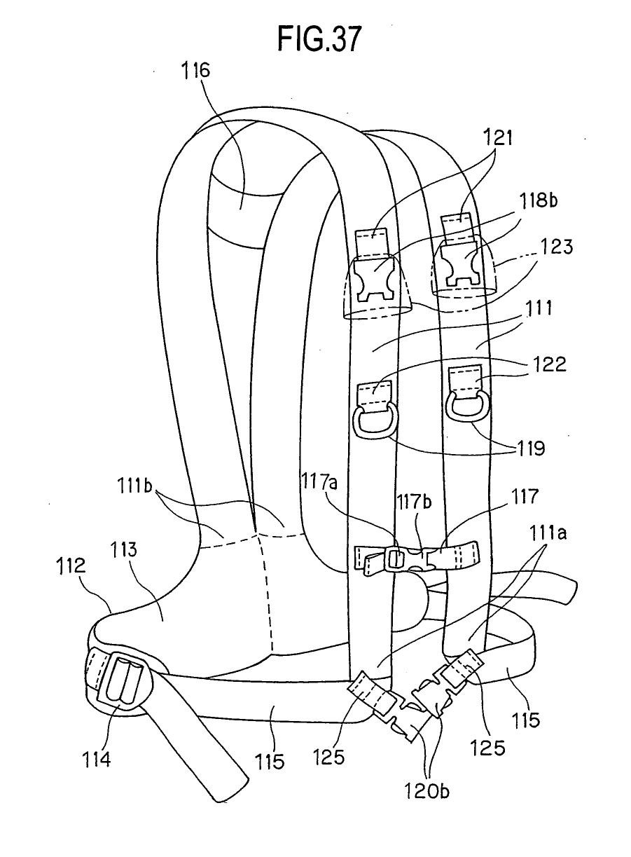

FIG. 36 shows a state in which the infant carrier main body 102 is developed from back side, FIG. 37 shows a state which the infant carrier main body 102 is put on by user (however, the user is not shown). As shown in these figures, the infant carrier main body 102 comprises a pair of shoulder belt 111 which the user put on around the shoulder, a waist belt 112 which the user put on around the waist. The waist belt 112 has a pad 113 which is made to touch to the back side of a waist portion of the user and a pair of side belts 115 joined to both side of the pad 113 through ladders 114 for adjusting the length. The distal end (corresponds to the lower end) 111a of the shoulder belt 111 continues to the distal end of the side belt 115. Each shoulder belts 111 and each side belts 115 are formed by one continued band material, the band material is folded back at the distal end 111a of shoulder belt 111 at the angle of 90°, and the shoulder belt 111 and the side belt 115 are formed. Back end 111b of the shoulder belt 111 is sewn together to the pad 113. For preventing the shoulder belts 111 being apart from each other, the shoulder belts 111 are joined each other by a connecting belt 116 on the back side. The front side of the one shoulder belt 111, a connecting belt 117 detachable by a pair of a male buckle 117a and a female buckle 117b is provided. However, the connecting belt 117 is not indispensable for the infant carrier of the present invention.

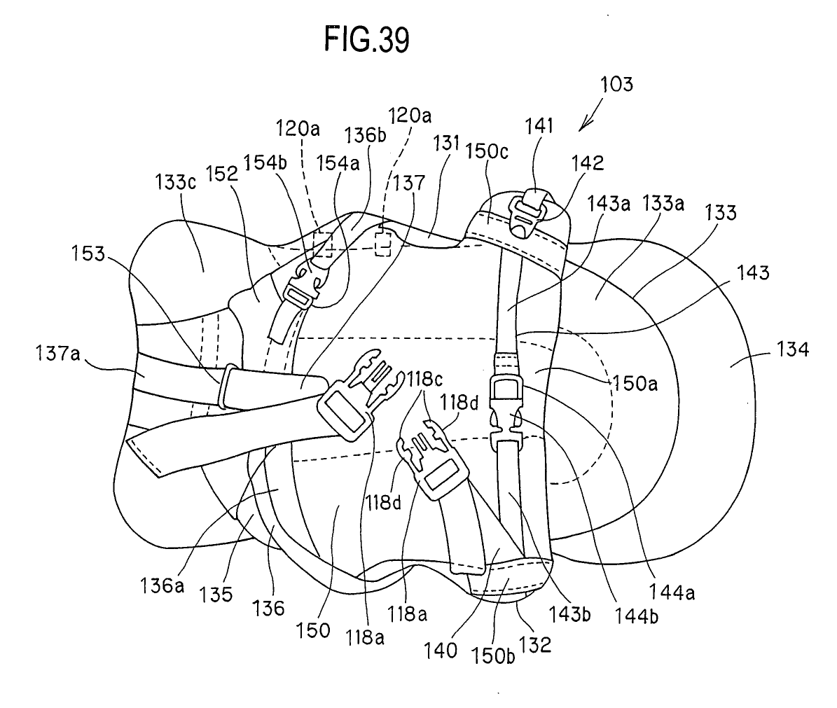

As fastenings to mount the attachment such as the horizontally-carrying seat 103, upper female buckles 118b, rings 119, and lower female buckles 120b are attached to the shoulder belt 111 respectively. Fastening fixing belts 121, 122 are sewn to the middle of the shoulder belt 111, and the upper female buckles 118b and the rings 119 are fastened at the distal end of those belts 121, 122 respectively. Further, the upper female buckles 118b are covered with pipe-like covers 123 (shown in imaginary line in FIG. 37). The upper ends of the covers 123 are sewn to the shoulder belt 111 together with the fastening fixing belt 121. Lower ends of the covers 123 are opened, and the male buckles 118a can be inserted to the upper female buckles 118b from the openings (with reference to FIG. 39).

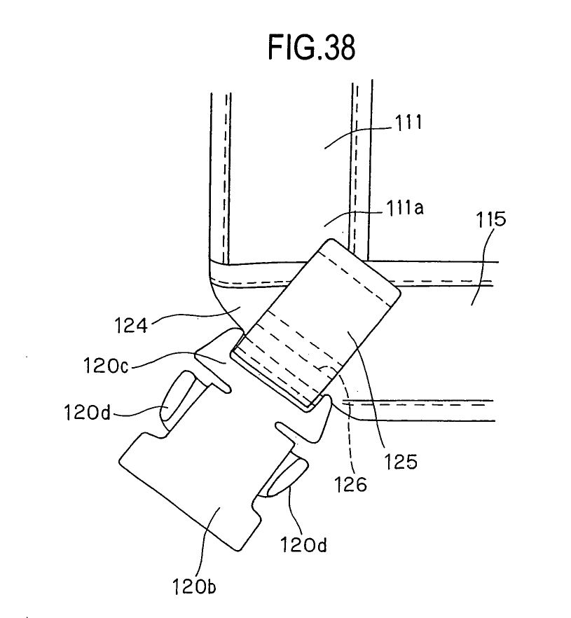

As shown in details in FIG. 38, the fastening fixing belt 125 is sewn to attach to the distal end 111a of the shoulder belt 111, that is to say, folded back portion 124 which becomes a border of the shoulder belt 111 and the side belt 115, and the lower female buckle 120b is fastened at the distal end of the fastening fixing belt 125. To restrain the lifting of the lower female buckle 120b from such as the shoulder belt 111 minimum, the fastening fixing belt 125 is sewn on the folded back portion 124 of the shoulder belt 111, and the position adjacent to the base (here, belt through portion 120c) of the lower female buckle 120b. That is, a stitch line 126 of the distal end side of the fastening fixing belt 125 is provided adjacent to the lower female buckle 120b. The sewing of the fastening fixing belt 125 is conducted integrally to the back side of shoulder belt 111 so that it functioned as sewing of folded back portion 124 between the distal end 111a of the shoulder belt 111 and the side belt 115.

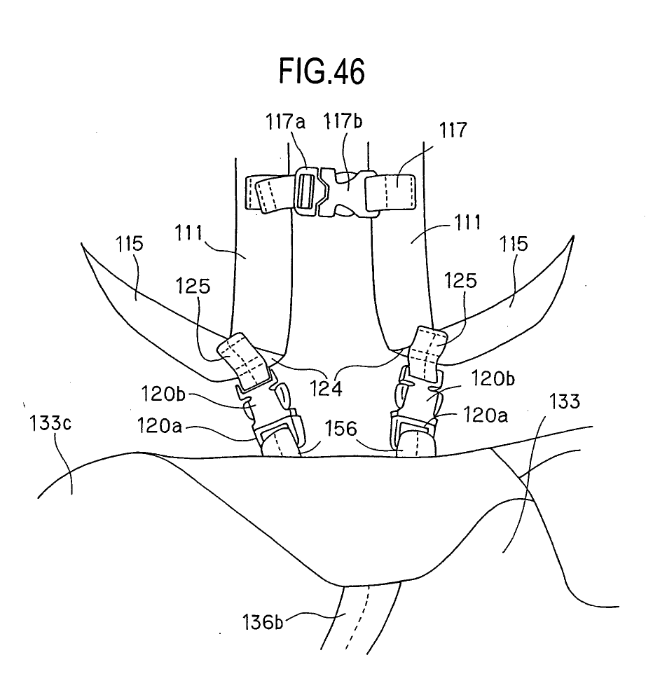

For distinguishing the fastening easily when attaching the attachment to the infant carrier main body 102, the fastenings of the infant carrier main body 102 are different in size or structure relating to the joining each other. That is, to distinguish from the upper part female buckle 118b and the lower female buckle 120b, the middle fastening is made to be ring 119. The upper female buckle 118b and the lower female buckle 120b are different in size each other, and the lower female buckles 120b are smaller than the upper female buckles 118b. The upper female buckle 118b and the lower female buckle 120b are different each other in the structure relating to the joint to the male buckle 118a, 120a as partner parts. That is, that the lower female buckle 120b comprises a pair of operation parts 120d to release the joining to the male buckle 120a (with reference to FIG. 46), while the upper female buckles 118b do not have such an operation part. The operation part for releasing the joint between the upper female buckle 118b and the male buckle 118a is provided in the male buckle 118a. The female buckle 117b of the connecting belt 117 is the type which does not have such an operation part, however, by using buckles smaller than the upper female buckle 118b as a female buckle 117b, it is considered that the upper female buckle 118b and the female buckle 117b can be surely distinguished. The pair of upper female buckles 118b can be mutually the same because an intended purpose is the same. A pair of the rings 119 mutually and a pair of female buckles 120b mutually are the same.

[About Horizontally-Carrying Seat]

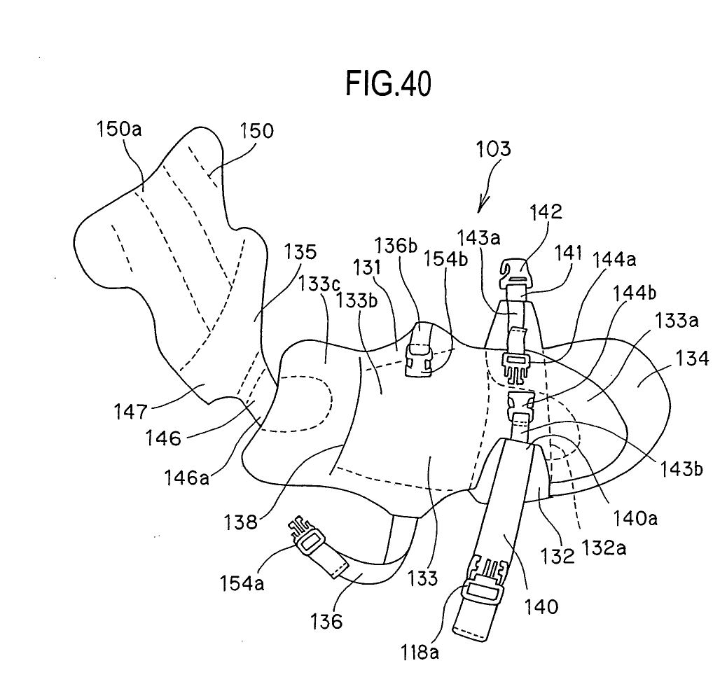

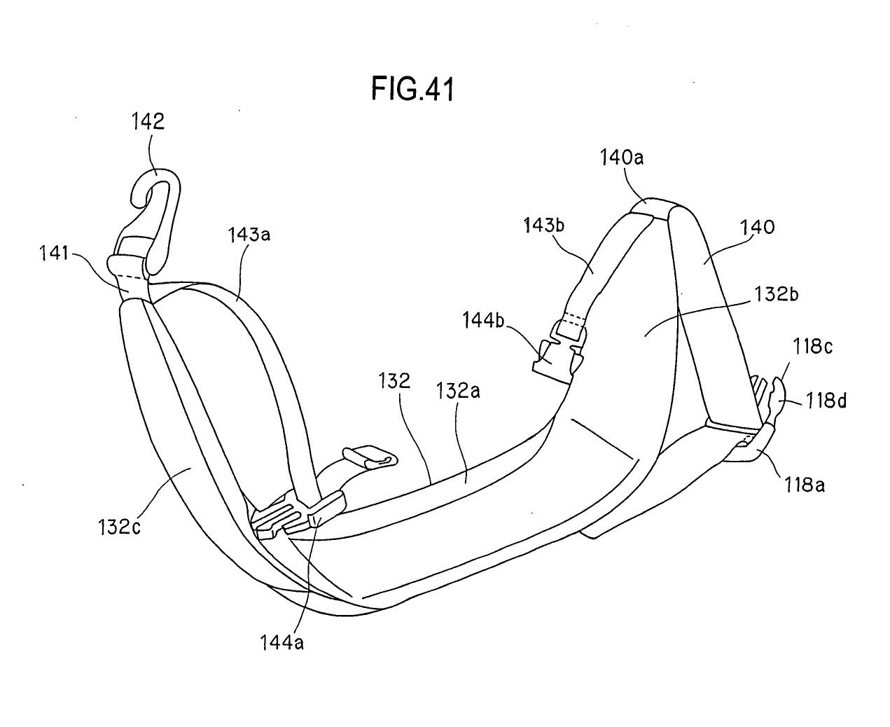

Next, the details of the horizontally-carrying seat 103 will be described. FIG. 39 is a plan view of the horizontally-carrying seat 103, and FIG. 40 is a developed view of the horizontally-carrying seat 103. As shown in these figures, the horizontally-carrying seat 103 comprises a seat main body 131 and a hanging board 132 which is detachable to the seat main body 131 (with reference to FIG. 41). The seat main body 131 comprises a mat 133 to lay down an infant, a head guard 134 provided to surround around a head supporting portion 133a of the mat 133, an abdomen pad 135 provided to cover a buttocks supporting portion 133b of the mat 133, an abdomen belt 136 extended from the both sides of the buttocks supporting portion 133b and is combined with the abdomen pad 135, and a buttocks belt 137 extended from the leg supporting portion 133c of the mat 133. The buttocks belt 137 is principally a thing for supporting the load of the buttocks side of the infant added to the mat 133, but it can be called as a crotch belt because it passed between crotches of the infant.

In inside of the mat 133, there is provided a core material (not shown) made by a resin to maintain shape of the mat 133. The core material is provided with it divided into the area from the head supporting portion 133a to the buttocks supporting portion 133b and the area of the leg supporting portion 133c, thereby the leg supporting portion 133c is foldable relative to the buttocks supporting portion 133b at the position of the boundary line 138 (with reference to FIG. 40).

As shown in FIG. 41, the hanging board 132 comprises a belt-shaped mat receiving portion 132a, a pair of arm portion 132b, 132c projecting in the same direction from both ends of the mat receiving portion 132a. As shown in FIG. 40 in broken line, the mat receiving portion 132a is passed through the inside of the mat 133 and lower than the core material, and functions to support the load added to the core material from the bottom. The arm portions 132b, 132c project above from both sides of the mat 133. As shown in FIG. 41 in detail, at the distal end of one arm portion 132b, the base 140a of the hang belt 140 is attached, and to the middle of the belt 140, the male buckles 118a are attached. The male buckle 118a is joined to the upper female buckle 118b of the above described infant carrier main body 102, and at a pair of nail portions 118c thereof, there is provided operation parts 118d for release a joint (with reference to FIG. 39). The length from the base 140a to the male buckle 118a is adjustable.

There is provided a hook 142 through the joining belt 141 at the distal end of the arm portion 132c of the opposite side. The hook 142 can be joined to the above described ring 119. The length of the joining belt 141 can not be adjusted. Further, as is clear from FIG. 41, there is provided connecting belts 143a, 143b at the distal ends of the arm portions 132b, 132c. A male buckle 144a and a female buckle 144b are attached to these connecting belts 143a, 143b respectively. As shown in FIG. 39, by attaching the hanging board 132 to the mat 133, and by joining the buckles 144a, 144b each other, the chest belt 143 across the horizontally-carrying seat 103 along the width direction will be constructed above the mat 133. The length from the distal end of the arm portion 132c to the male buckle 144a is adjustable.

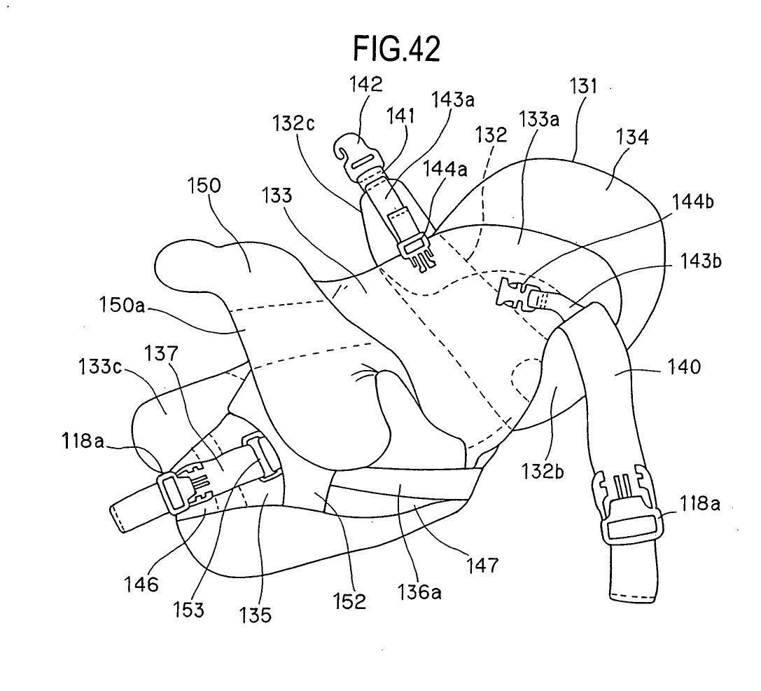

As shown in FIG. 40, an abdomen pad 135 have a crotch holding portion 146 in which the base 146a thereof is joined to the back end middle portion of the leg supporting portion 133c and an abdomen holding portion 147 extending along the width direction of both sides of the horizontally-carrying seat 103 continuously to the crotch holding portion 146. A chest pad 150 is provided continuously to the distal end of the abdomen holding portion 147. This abdomen pad 135 and the chest pad 150 are foldable integrally with the connection position between the base 146a of the crotch holding portion 146 and the leg supporting portion 133c being as an axis. Both pads 135, 150 can be folded back about near 180 in maximum from the state lapped on the mat 133. As shown in FIG. 42, the chest pad 150 is foldable relative to the abdomen pad 135.

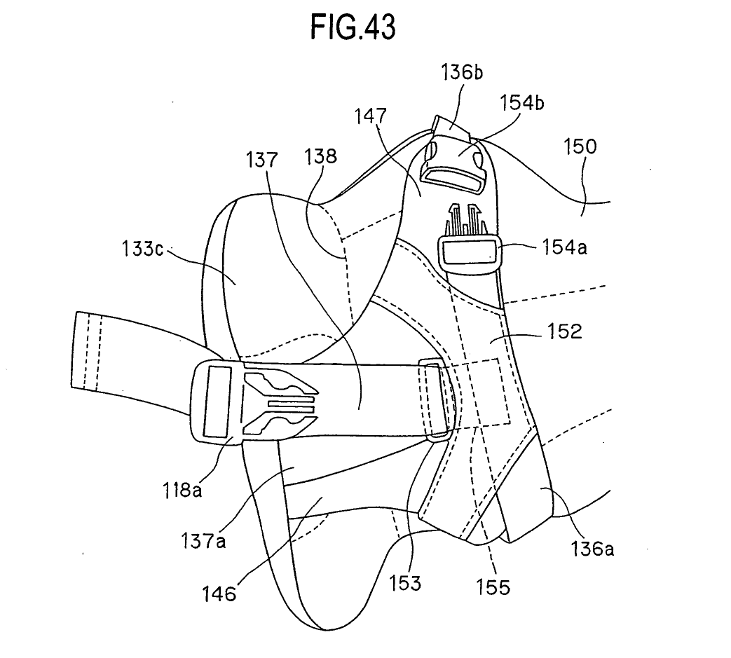

As shown in FIG. 43 in detail, in the front side of the abdomen pad 135, there is provided a belt through portion 152 to make the abdomen belt 136 to pass through and a ring 153. As shown in FIG. 39 and FIG. 40, there are provided a pair of connection belts 136a, 136b on both sides of the buttocks supporting portion 133b of mat 133. There is provided a male buckle 154a and a female buckle 154b in these connecting belts 136a, 136b respectively, by joining those buckle 154a, 154b each other, one abdomen belt 136 is formed. One of the connection belts 136a is provided sufficiently longer than overall width of the abdomen pad 135. When the horizontally-carrying seat 103 is used, as show in FIG. 43,the joining belt 136a is made to pass through the belt through portion 152 with the male buckle 154a being forehead, by the male buckle 154a being connected with female buckle 154b, the abdomen belt 136 is joined to the abdomen holding portion 147 of the abdomen pad 135 each other. The length from the joining position between the joining belt 136a and the mat 133 to the male buckle 154a can be adjusted.

As shown in FIG. 39, the buttocks belt 137 is arranged along the surface of the crotch holding portion 146 of the abdomen pad 135, and the base 137 thereof is joined to the back end middle of the leg supporting portion 133c of the mat 133 as same as the crotch holding portion 146. The buttocks belt 137 is made to pass through the ring 153, and the male buckle 118a is attached to the end of the ring 153. The male buckle 118a is to be joined to the upper female buckle 118b of the shoulder belt 111 side as same as the male buckle 118a provided to above described hanging board 132. As shown in FIG. 43, the ring 153 is fixed to the surface of the abdomen holding portion 147 of the abdomen pad 135 through the ring fixing belt 155. The ring fixing belt 155 is arranged in the position covered to the belt through portion 152, the joining belt 136a is inserted in the belt through portion 152 form a side of the belt through portion 152, is passed above the ring fixing belt 155, and is drawn to the opposite side of the belt through portion 152. Therefore, when the buttocks belt 137 is lifted from the upper buckle 118b of the infant carrier main body 102, the abdomen belt 136 also lifted together. As a result, hanging reaction force acts on the buttocks belt 137 is dispersed to the three points, those are connection positions between the abdomen belt 136 and the buttocks supporting portion 133b and a connection position between the buttocks belt 137 and the leg supporting portion 133c. Thereby, the buttocks side of the mat 133 can be hang and supported at so-called three points, thus high stability can be obtained.

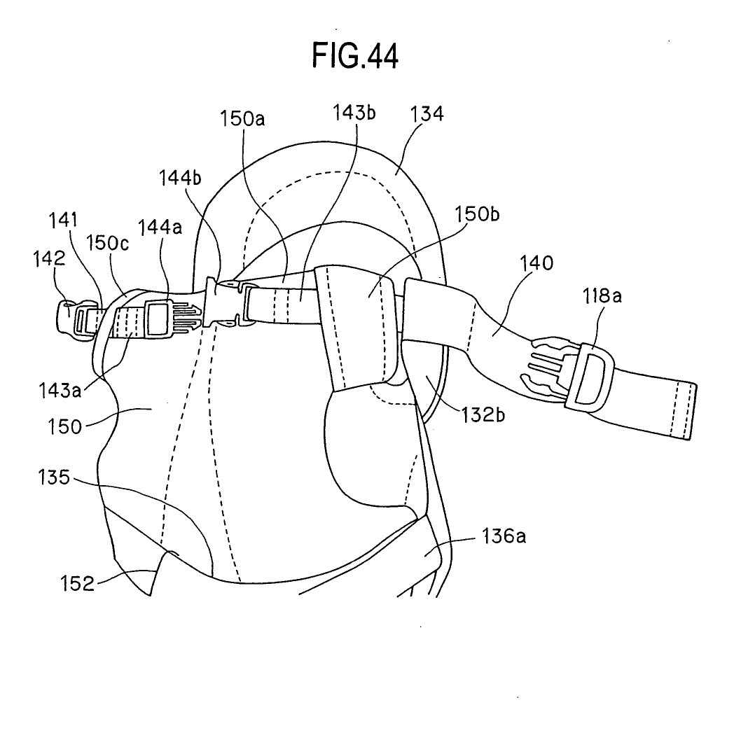

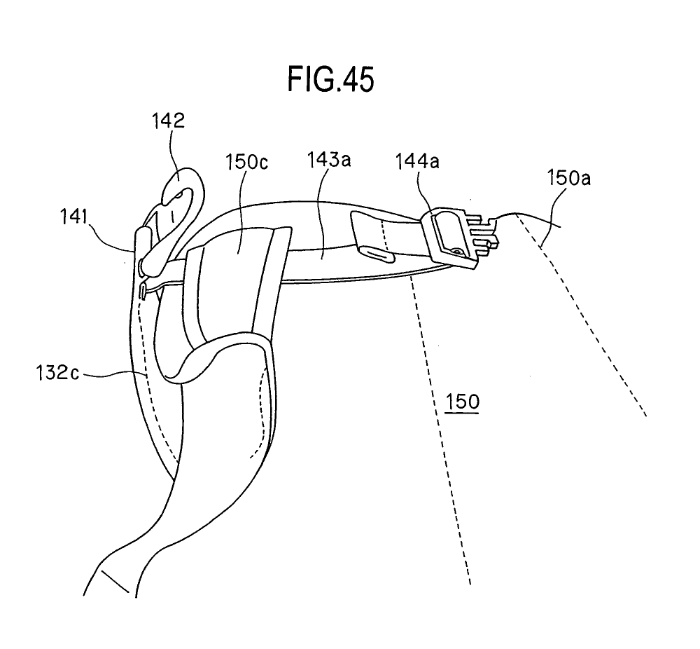

As shown in FIG. 39, a chest pad 150 is provided so as to reach to the attached position of the hanging board 132 when it is folded back to the mat 133 side. As shown in FIG. 44 and FIG. 45 in detail, there are provided belt through portions 150b, 150c for passing the connecting belt 143a, 143b of the chest belt 143 through on the both sides of the distal end portion 150a of the chest pad 150. By making the connecting belt 143a, 143b to pass through these belts through portion 150b, 150c, and by joining the buckles 144a, 144b, the distal end portion 150a of the chest pad 150 is hung and supported by the chest belt 143, and dropping of the chest pad 150 to the mat 133 is prevented, thus the adequate space can be obtained therebetween.

As shown in FIG. 46, at one of the side edges (upper edge in FIG. 39) along the width direction of the mat 133, a pair of male buckle 120a is provided through the fastening fixing belt 156. These male buckles 120a are joined to the lower female buckles 120b provided on the infant carrier main body 102. The fastening fixing belt 156 is sewn on the back side of the mat 133 over almost all length, and the male buckle 120a is attached to the distal end thereof. For restraining the swing of the male buckle 120a relative to the mat 133 minimum, the fastening fixing belt 156 is also sewn on the mat 133 immediate adjacent to the male buckle 120a.

[About How to Use the Horizontally-Carrying Seat]

Next, how to use the horizontally-carrying seat 103 will be described. When the horizontally-carrying seat 103 is used, firstly, as shown in FIG. 40, the hanging board 132 is attached to the mat 133 and the abdomen pad 135 and the chest pad 150 are opened. In this state, an infant is put on the mat 133, and the abdomen pad 135 is folded back to the mat 133 side, then the infant is covered with the pad 135, 150. Next, the connecting belt 136a, 136b are made to pass-through the belt through portion 152, and the abdomen belt 136 and the abdomen pad 135 are assembled each other by joining the buckles 154a, 154b each other. At this time, by adjusting the position of the male buckle 154a, the length of the abdomen belt 136 can be adjusted to the size around the abdominal portion of the infant. In addition, the connecting belts 143a, 143b are made to pass through the belt through portion 150b, 150c of the chest pad 150, the chest belt 143 and the chest pad 150 are assembled each other by joining the buckle 144a, 144b each other. At this time, by adjusting the position of the male buckle 144a, the length of the chest belt 143 can be adjusted to the size around the chest of the infant.

After the infant laid on the mat 133 is covered with the abdomen pad 135 and the chest pad 150 according to the above described procedure, the horizontally-carrying seat 103 is joined to the infant carrier main body 102 as follows. That is, as shown in FIG. 35, the male buckle 118a attached to the hanging board 132 is joined to the upper female buckle 118b of the shoulder belt 111 of the left shoulder side (the right side in FIG. 37) of the infant carrier main body 102, the hook 142 is joined to the ring 119 of the same side. In addition, the male buckle 118a attached to the buttocks belt 137 is joined to the upper female buckle 118b of the shoulder belt 111 for opposite side, that is the right side. As shown in FIG. 46, the male buckle 120a is joined to the lower female buckle 120b respectively. Thereby, as shown in FIGS. 34 and 35, the horizontally-carrying seat 103 is mounted on the infant carrier main body 102 and the infant can be folded in a horizontally-carrying state.

As described above, according to the infant carrier 101 of this embodiment, even if in the configuration in which the horizontally-carrying seat 103 is hung from the connection position between the upper female buckle 118b and male buckle 118a or the joining positioned between the ring 119 and the hook 142, by the male buckle 120a arranged in side edge of the horizontally-carrying seat 103 being connected with the lower female buckle 120b provided the lower of infant carrier main body 102, the swing of the horizontally-carrying seat 103 about the hung support point by the upper female buckle 118b or the ring 119 is restrained. Therefore, even if user bends the body forward or twists the body left of right direction, the horizontally-carrying seat 103 is not apart from the infant carrier main body 102, thus the user does not have to attach a hand to this for stopping the swing of the horizontally-carrying seat 103. Therefore the burden to the user can be reduced, and both hands of user become free, consequently the usability of the infant carrier 101 improves.

Because the structures relative to the size or the joining of the upper female buckle 118b, the ring 119 and the lower female buckle 120b, as a fastening for the attachment provided on the infant carrier main body 102, are different each other, when the horizontally-carrying seat 103 is put on, an appropriate fastening can be easily distinguished. Further, because the chest of the infant is covered by the chest pad 150, the infant supported by the horizontally-carrying seat 103 can be surely protected.

[About Vertically-Carrying Seat]

Next, an example of the vertically-carrying seat which is used when an infant is carried in a horizontally-carrying state will be described. FIG. 47 is a front view of the vertically-carrying seat used in the infant carrier 101, and FIG. 48 is a back side view of the vertically-carrying seat. As shown in these figures, a vertically-carrying seat 160 comprises a bottom 162 made to pass through between crotches of the infant, a body cover portion 163 continued to above the bottom 162, a middle supporting portion 164 continued to above the body cover portion 163, a head keeping 165 continued to above the middle supporting portion 164.

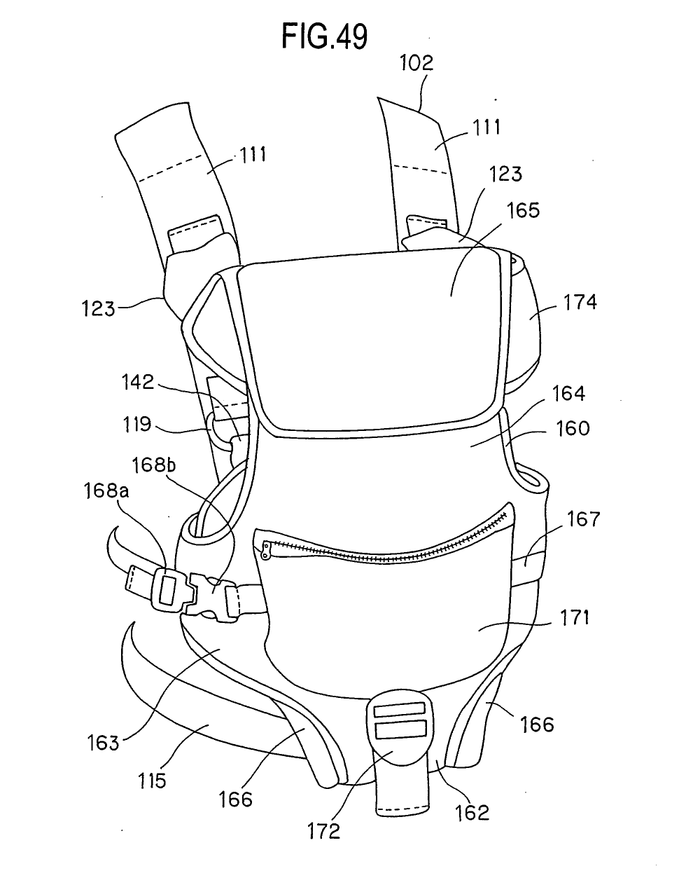

The bottom 162 is a portion on which the buttocks of the infant are put, and there is provided foot passing portions 166 to passing through foot of the infant on the both sides thereof. The body cover portion 163 is formed in folio so that it can be wrapped around the body or the infant, it is assembled as a pipe-like by joining hook 163a, 163b provided at the both ends each other. The hooks 163a, 163b are provided as a pair at the top-and-bottom, but only the upper hook 163a and the lower hook 163b are shown in FIG. 48. The body belt 167 is provided around the body cover portion 163. By male buckle 168a and the female buckle 168b of distal end of the body belt 167 making to be connected with each other (with reference to FIG. 49), the body belt 167 is connected as one loop-like, thus the body cover portion 163 is surrounded.

A buttocks belt 169 extending along the top-and-bottom direction is provided on the body cover portion 163. The buttocks belt 169 is passed to the back and forth of the body cover portion 163 through the bottom 162 and the both ends are sewn on the body cover portion 163. On the back side of the vertically-carrying seat 160, the buttocks belt 169 is sewn on the cover portion 163 in an integrated fashion with a body belt 167 at the crossing portion 170. On the other hand, on the surface side of the vertically-carrying seat 160, the buttocks belt 169 is sewn on the body belt 167, however, the sewing point cannot be seen because it is covered by a pocket 171. A ladder 172 for adjusting a length is provided on the way of the buttocks belt 169. By adjusting the length of buttocks belt 169 by utilizing the ladder 172, the depth of bottom 162 can be changed depending on the physique of the infant.

Further, on the back side of the bottom 162 (FIG. 48), a pair of male buckle 120a capable of joining to the lower female buckle 120b of the infant carrier main body 102 is attached through the fastening fixing belt 173. In addition, on the body belt 167, a pair of hook 142 capable of joining to the ring 119 of the infant carrier main body 102 are attached through the fastening fixing belt 173. A support belt 174 is passed through the head keeping 165. On both ends of support belt 174, the male buckle 118a capable of joining to the upper female buckle 118b of the infant carrier main body 102 is fixed through the fastening fixing belt 175.

The above-described vertically-carrying seat 160 is used as follows. At first, the infant is put up on the bottom 162 in the back-looking or the forward-looking state, both legs are passed through the foot passing portion 166, and the waist of the infant is covered by the cover portion 163, and the hooks 163a, 163b are jointed each other. Next, the buckles 168a, 168b are connected each other, and the body belt 167 is connected, and then the infant in the body cover portion 163 is restrained moderately. Then, the position of the male buckle 168a of the body belt 167 is adjusted to the physique of the infant. When the infant is put on in the back-looking direction (the direction in which the infant faces to a user), the middle supporting portion 164 functions as a back holding portion of the infant, when the infant is put on in the forward-looking state, the middle supporting portion 164 functions as a breast plate portion of the infant.

After an infant is put on the vertically-carrying seat 160 according to the above-described procedure, the vertically-carrying seat 160 is mounted on the infant carrier main body 102 as follows. The horizontally-carrying seat 103 is joined to the infant carrier main body 102 as follows. That is, the male buckle 118a attached to the hanging board 132 is joined to the upper female buckle 118b of each shoulder belt 111 of the infant carrier main body 102, the hook 142 is jointed to the ring 119 of the shoulder belt 111. The male buckle 120a of the bottom 162 is joined to the lower female buckle 120b of the infant carrier main body 102. Thereby, as shown in FIG. 49, the vertically-carrying seat 160 is attached to the infant carrier main body 102 and the infant can be held in the vertically-carrying state. Before the infant is held in the vertically-carrying seat 160, the male buckle 120a may be joined to the lower female buckle 120b of the infant carrier main body 102.

As described above, when the infant carrier main body 102 is attached to the vertically-carrying seat 160, because the size or the structure of the upper female buckle 118b, the ring 119 and the lower female buckle 120b, as fastening for attachment provided to the infant carrier main body 102, are different each other, an appropriate fastening can be distinguished easily. The vertically-carrying seat described above is an example, and various kinds of configuration can be used for the vertically-carrying seat.

In above-described embodiment, the upper female buckle 118b and ring 119 correspond to the upper fastening and the lower female buckle 120b corresponds to the lower fastening respectively. The hanging board 132 (however, including the hanging belt 140, the male buckle 118a, and the connection belt 141 and the hook 142 as the accessories) corresponds to the head side hang tools, the abdomen pad 135 (however, including the belt passing 152, the ring 153 and the ring fixing belt 155 as the accessories), the abdomen belt 136 (including the buckle 154a, 154b) and the buttocks belt 137 (including the male buckle 118a) correspond to the buttocks side hung tools respectively, and the combination thereof corresponds to the hang tools.

In the present invention, the male and female relation of buckles 118a, 118b, and the male and female relation of the buckles 120a, 120b can be inverted relative to the second embodiment described above. That is to say, the male buckles 118a, 120a can be mounted on the infant carrier main body 102, and the female buckles 118b, 120b can be provided on the horizontally-carrying seat 103 or the vertically-carrying seat 160. The lower female buckle 120b and the male buckle 120a fit with this can be one respectively. The fastening for stopping the swing can be provided both sides of the horizontally-carrying seat, and the infant carrier may be constructed as horizontally-carrying exclusive use.

As for a technological concept in which size and structure of a fastening of an infant carrier main body are made to be different each other, it is not limited to the infant carrier in which a lower fastening and a swing-preventing fastening are provided, but it can be applied to various infant carrier in which the infant carrier main body put on by a user and an attachment such as a horizontally-carrying seat or a vertically-carrying seat are assembled and used. In addition, as for a technological concept in which an abdomen pad is provided continuously from a chest pad, it is not limited to the infant carrier in which a lower fastening and a swing-preventing fastening are provided, but it can be applied to various infant carrier in which the infant carrier main body worn by user and a horizontally-carrying seat are assembled and used.

1-49. (canceled)

50. An infant carrier comprising an infant carrier main body to be put on by a user and a horizontally-carrying seat to be suspended from the infant carrier main body to hold an infant in a horizontally-carrying state, wherein
the horizontally-carrying seat comprises: a seat main body comprising a head supporting portion; and a hanging board arranged so as to cross the head supporting portion along a width direction and on which a rigidity is exerted by a core material consisting of a hard material, and through the hanging board, both sides of the width direction of the head supporting portion is hung from the infant carrier main body.

51. The infant carrier according to claim 50, wherein a back board consisting of a hard material is provided in an inside of the seat main body, and the hanging board is arranged so as to be overlapped in a bottom of the back board.

52. The infant carrier according to claim 50, wherein the hanging board is detachable to the seat main body.

53. The infant carrier according to claim 50, wherein a hanging belt for hanging the hanging board to the infant carrier main body is provided at an end of the hanging board, a belt side fastening and a hook capable of engaging with the belt side fastening are provided on the hanging belt, a body side fastening through which the hanging belt can be passed is provided on the infant carrier main body, a board side fastening through which the hanging belt can be passed is provided on the other end of the hanging belt, and by engaging the hook through which the body side fastening and the board side fastening are passed successively with the belt side fastening, both ends of the hanging belt is hung and supported from the body side fastening.

54. The infant carrier according to claim 53, wherein an attaching direction of the hanging board to the seat main body is changeable relative to a width direction of the seat main body.

55. The infant carrier according to claim 53, wherein an excess length portion of the hanging belt is drawn from the hook so as to be folded back, in the state in which the hook passes through the board side fastening, the excess length portion hangs on the board side fastening, and the hook becomes incapable of passing through the board side fastening.

56. The infant carrier according to claim 53, wherein the board side fastening is ring-like and bent to project to an outside of the width direction of the seat main body seeing from the side.

57. The infant carrier according to claim 53, wherein a stopper to restrain the slipping of the hanging belt from the body side fastening is provided on the hanging belt.

58. An infant carrier in which a vertically-carrying seat constructed as a separated part from an infant carrier main body is mounted on the infant carrier main body which a user put on a chest or a back being touched, the infant is supported in a vertically-carrying state or a horizontally-carrying state by a vertically-carrying seat, and the vertically-carrying seat is supported by the infant carrier main body, wherein a back board formed by a hard material is provided on the infant carrier main body.

59. The infant carrier according to claim 58, wherein a shoulder belt mounted around a shoulder of a user is attached to an upper end portion of the infant carrier main body, a waist touching portion put on around a waist of the user is provided on a lower end portion of the infant carrier main body, and the back board is extended along an top-and-bottom direction from an attached position of the shoulder belt to a waist touching portion.

60. The infant carrier according to claim 59, wherein on the lower part of the back board, a folding portion which is foldable upwardly is provided.

61. The infant carrier according to claim 60, wherein a folding axis of the folding portion is located upper than the upper end of the waist touching portion.

62. The infant carrier according to claims 58, wherein an underarm belt to be joined to the infant carrier main body through the under arm of the infant is provided on the vertically-carrying seat.

63. The infant carrier according to claim 62, wherein a rigidity of the vertically-carrying seat is set lower than the back board.

64. An infant carrier in which a vertically-carrying seat constructed as a part separated from an infant carrier main body is mounted on the infant carrier main body which a user put on and a bag-like portion for accommodating an infant vertically is formed between the infant carrier main body and the vertically-carrying seat, wherein
a sheet fastening portion for fastening the vertically-carrying seat is provided on the infant carrier main body, a bottom supporting portion folded back to the seat fastening portion of the infant carrier main body so as to form a bottom portion of the bag-like portion of the infant carrier main body is provided on a lower portion of the vertically-carrying seat, and a joining tool capable of joining to the sheet-fastening portion is provided on a distal end of the bottom supporting portion so that the position is adjustable along the top-and-bottom direction of the vertically-carrying seat.

65. The infant carrier according to claim 64, wherein either one of male and female buckles capable of being engaged with each other is provided on the sheet fastening portion, the other buckle is attached to the bottom supporting portion of the vertically-carrying seat through an adjust belt extended along an top-and-bottom direction as a joining portion, and an attaching position to the adjust belt of the other buckle is adjustable.

66. The infant carrier according to claim 65, wherein a plural pairs of the buckles is provided on each of the sheet fastening portion and the bottom supporting portion.

67. The infant carrier according claim 64, wherein a swing-preventing band to sandwich the bottom supporting portion therebetween is provided on a position lower than the sheet-fastening portion of the infant carrier main body.

68. An infant carrier in which a vertically-carrying seat constructed as a part separated from an infant carrier main body is mounted on the infant carrier main body which user put on, and a bag-like portion for accommodating an infant vertically is formed between these infant carrier main body and the vertically-carrying seat, wherein
a plurality of sheet fastening portions for fastening the vertically-carrying seat is provided on the infant carrier main body with each positions thereof shifted along the top-and-bottom direction, a bottom supporting portion folded back to the seat fastening portion of the infant carrier main body so as to form a bottom portion of the bag-like portion is provided on a lower portion of the vertically-carrying seat, and a joining tool capable of selectively joining to either one of the sheet-fastening portions is provided at the distal end of the bottom supporting portion.

69. An infant carrier in which a vertically-carrying seat constructed as a separated part from an infant carrier main body is mounted on the infant carrier main body which a user put on either of a chest or a back selectively, an infant is supported in a vertically-carrying state or a back-carrying state depending on the direction of the vertically-carrying seat, and a vertically-carrying seat is supported by the infant carrier main body, wherein
the infant carrier main body comprises a base portion made to be touched to a chest of a back of the user, a shoulder belt extended from a base portion and mounted around a shoulder of the user, and the waist touching portion mounted around a waist of the user, and the waist touching portion is made to be displaced relative to the base portion along a top-and-bottom direction.

70. The infant carrier according to claim 69, wherein means for holding the waist touching portion at either of a plurality of pre-decided positions relative to the base portion is provided on the base portion.

71. The infant carrier according to claim 69, wherein a pocket capable of receiving a lower end portion of the base portion is provided on the waist touching portion, a folding portion which can be folded within the pocket is provided on a lower end of the base portion, and a lower end of the folding portion is joined to the waist touching portion.

72. An infant carrier comprising an infant carrier main body which is put on by a user and a horizontally-carrying seat to be suspended from the infant carrier main body for holding an infant in a horizontally-carrying state, wherein a pair of right-and-left fastening for hanging the horizontally-carrying seat is provided on the infant carrier main body, and a head side hang tool for hanging the head side of the horizontally-carrying seat from the fastening of either one of the pair of fastenings and a buttocks side hang tool for hanging the buttocks side of the horizontally-carrying seat from the other fastening are provided on the horizontally-carrying seat, and lengths of each hang tools are set so that the head side of the horizontally-carrying seat can be held in a position higher than the buttocks side when the head side hang tool and the buttocks side hang tool are mounted on one side fastening and the other fastening.

73. An infant carrier comprising an infant carrier main body to be put on by a user and a horizontally-carrying seat to be suspended from the infant carrier main body for holding an infant in a horizontally-carrying state, wherein
a head side hang tool and a buttocks side hang tool for hanging a head side and a buttocks side of the horizontally-carrying seat from the infant carrier main body are provided on the horizontally-carrying seat,
the head side hang tool is provided so as to support the head side of the horizontally-carrying seat on both sides of the width direction of the horizontally-carrying seat, and
the buttocks hang tool is provided so as to support the buttocks side of the horizontally-carrying seat at three points of both sides of the width direction of the horizontally-carrying seat and a middle of a width direction of a back end of the horizontally-carrying seat.

74. The infant carrier according to claim 73, wherein the buttocks side hang tool has an abdomen belt extended form both sides of a width direction of the horizontally-carrying seat, a buttocks belt extended from a center of a width direction of the horizontally-carrying seat back end, and an abdomen pad arranged at the back end portion of the horizontally-carrying seat and covers the abdomen of the infant, and by the abdomen belt and the buttocks belt being connected each other through the abdomen pad, the abdomen belt and the buttocks belt are made to be capable of being hung and supported integrally from the infant carrier main body.

75. The infant carrier according to claim 74, wherein on a back end portion of the horizontally-carrying seat, a buttocks supporting portion for supporting a buttocks of the infant and a leg supporting portion which is foldable to the buttocks supporting portion and for supporting the legs of the infant are provided, an abdomen belt is extended form the both sides of the width direction of the buttocks supporting portion, while a buttocks belt is extended from a center of a width direction of the back end of the legs.

76. The infant carrier according to claim 74, wherein a back board as a core material to support the infant is embedded in the horizontally-carrying seat, and the back board is made to bend by a load occurred when the infant is supported with a central line of a width direction being bottom.

77. An infant carrier comprising an infant carrier main body to be put on by a user and a horizontally-carrying seat to be suspended from the infant carrier main body for holding an infant in a horizontally-carrying state, wherein
a mat for laying an infant and a head guard arranged to surround around a head of an infant is provided on the horizontally-carrying seat, a core material is provided on the mat and the head guards respectively, and a vent is provided on the core material respectively.

78. An infant carrier comprising an infant carrier main body to be put on by a user and a horizontally-carrying seat to be suspended from the infant carrier main body for holding an infant in a horizontally-carrying state, wherein a back board as a core material supporting from the head to the buttocks of the infant and a seating board as a core material for supporting legs of the infant are embedded in the horizontally-carrying seat, and the seat is enlarged in width direction wider than a buttocks edge portion of the back board.

79. An infant carrier comprising an infant carrier main body to be put on by a user and a vertically-carrying seat for forming a back-like portion to accommodate an infant vertically between the infant carrier main body by being combined with the infant carrier main body, wherein
a ring-like fastening to fasten the vertically-carrying seat is provided on the infant carrier main body, a seat main body for moving the infant toward the infant carrier main body, and a joining belt extending from the seat main body for joining the vertically-carrying seat to the fastening are provided on the vertically-carrying seat, either one a pair of the male and female buckles capable of being engaged each other is provided on the joining belt and the other buckle is provided on the seat main body respectively, the one of the buckles is capable of passing through the fastening, an excess length portion of the joining belt is drawn from the one of the buckles so as to be folded back, and in the state that the one of the buckles is passed through the fastening, the excess length portion hangs in the fastening, and the one of the buckles becomes incapable of passing through the fastening.

80. An infant carrier comprising an infant carrier main body to be put on by a user and a vertically-carrying seat for forming a back-like portion to accommodate an infant vertically between the infant carrier main body by being combined with the infant carrier main body, wherein
a head support for covering the head of an infant, a support belt extending from both sides of the head support and for joining to the infant carrier main body are provided on the vertically-carrying seat, the head support is foldable toward the outside of the vertically-carrying seat, the support belt can be joined to the infant carrier main body so that the twist of the support belt is dissolved when the head support is folded back in the half-turned state.

81. An infant carrier comprising an infant carrier main body to be put on by a user and a vertically-carrying seat for forming a back-like portion to accommodate an infant vertically between the infant carrier main body by being combined with the infant carrier main body, wherein a ring-like fastening to fasten the vertically-carrying seat is provided on the infant carrier main body, and the fastening bends so as to project to the infant carrier main body side seeing from the side.

82. An infant carrier comprising an infant carrier main body to be put on by a user and a vertically-carrying seat for forming a back-like portion to accommodate an infant vertically between the infant carrier main body by being combined with the infant carrier main body, wherein
an inner packing material having a vent hole is embedded in the vertically-carrying seat, the inner packing material is covered with a three-dimensional mesh fabric.

83. An infant carrier comprising an infant carrier main body to be put on by a user and a vertically-carrying seat for forming a back-like portion to accommodate an infant vertically between the infant carrier main body by being combined with the infant carrier main body, and an infant can be put in the back-like portion directing either of a forward-looking or a backward-looking direction, and a width of the lower of the vertically-carrying seat is adjustable.

84. An infant carrier comprising an infant carrier main body to be put on by a user and a vertically-carrying seat for forming a back-like portion to accommodate an infant vertically between the infant carrier main body by being combined with the infant carrier main body, wherein
a shoulder belt mounted around a shoulder of the user is provided on the infant carrier main body with length adjustable, a shoulder belt band for folding and holding an excess length portion of the shoulder belt which length thereof has been adjusted is provided.

85. A joining structure of a belt-shaped article, in which either one of a pair of male and female buckles capable of engaging each other is attached to the belt-shaped article, the other buckle is attached to the fixed portion to be joined to the belt-shaped article, and the belt-shaped article and the fixed portion are made to be detachable, wherein
the buckle attaching to the fixed portion is fixed to the fixed portion at the back and forth of the buckle relative to an attaching or a detaching direction of the belt-shaped article.

86. The joining structure of a belt-shaped article according to claim 85, wherein belt through portions are provided on each of front or back ends of the buckle attached to the fixed portion, and a buckle fixing belt is made to be passed through between these belt through portions, and the both end portions of the buckle fixing belt is fixed to the fixed portion.

87. An infant carrier comprising an infant carrier main body provided with a shoulder belt to be put on around a shoulder of an user and a waist touching portion to be put on around a waist of the user, either one of a pair of mutually engagable male and female buckles is attached to the shoulder belt and the other buckle is attached to the waist touching portion, and the shoulder belt and the waist touching portion are made to be detachable, wherein
a buckle attached to the waist touching portion is fixed to the waist touching portion at back and forth of the buckle along the attaching or detaching direction of the shoulder belt.

88. The infant carrier according to claim 87, wherein belt through portions are provided on each of front and back ends buckles fixed to the waist touching portion, and a buckle fixing belt is made to be passed through between these belt through portions, and both end portions of the buckle fixing belt are fixed to the fixed portion.

89. A fixing side buckle attached to a fixed portion to which a belt-shaped article is to be joined and a buckle fixed to the belt-shaped article is attached and detached, wherein a belt through portion is provided at front and back ends relative to an attaching or detaching direction of the belt-shaped article, a buckle fixing belt for fixing the fixed side buckle to a fixed portion is made to be capable of inserting between the belt through portions.

90. An infant carrier comprising an infant carrier main body to be put on by a user and a horizontally-carrying seat to be suspended from the infant carrier main body for holding an infant in a horizontally-carrying state, wherein
on the infant carrier main body, as fastenings for attaching the horizontally-carrying seat, an upper part fastening for hanging the horizontally-carrying seat and a lower part fastening disposed under than the upper fastening are provided, and on the horizontally-carrying seat, a hang tool for hanging the horizontally-carrying seat from the upper fastening and a swing-stopping fastening provided on the one side of the width direction of the horizontally-carrying seat and can be joined to the lower part fastening are provided.

91. The infant carrier according to claim 90, wherein a pair of shoulder belts to be put on around a shoulder of a user and a waist belt to be put on around a waist of the user continuously from an under end of the shoulder belt are provided on the infant carrier main body, the upper fastening is provided on respective middle of the a pair of shoulder belts, the lower part fastening is provided on a bottom end of the shoulder belt or the waist belt.

92. The infant carrier according to claim 91, wherein each of the lower part fastening and the swing-preventing fastening are attached to the infant carrier main body and the horizontally-carrying seat through the fastening fixing belt, and at a position adjacent to each of the lower part fastening and the swing-preventing fastening, the fastening fixing belt is sewn on the infant carrier main body and the horizontally-carrying seat.

93. The infant carrier according to claim 90, wherein on the infant carrier main body, a left and right pair of upper fastenings is provided, and on the horizontally carrying seat, as a hang tool, a head side hang tool for hanging the head side of the horizontally carrying seat from the upper fastening of either one of the pair of upper fastenings, and a buttocks side hang tool for hanging the buttocks side of the horizontally carrying seat from the other upper fastening are provided.

94. The infant carrier according to claim 93, wherein an abdomen pad covering an abdomen of the infant is provided on the buttocks support side of the horizontally-carrying seat, a chest pad covering a chest of the infant is continuously provided on the upper end of the abdomen pad, a chest belt joining the head side hang tool and the chest pad is provided on the horizontally-carrying seat.

95. The infant carrier according to claim 90, wherein the upper fastening and the lower part fastening are different each other in at least either one of structures relating to size or joining.

96. The infant carrier according to claim 90, wherein an abdomen pad covering the abdomen of the infant is provided on the buttocks side of the horizontally-carrying seat, and a chest pad covering a chest of the infant is provided continuously to the upper end of the abdomen pad.

97. An infant carrier comprising an infant carrier main body to be put on by a user and an attachment to be joined to the infant carrier main body for holding the infant, wherein on the infant carrier main body, a plurality kinds of fastenings used for mutually different purposes respectively for joining the attachment are provided in different positions, and each of the fastenings of the plurality kinds of fastenings are different each other in at least either one of size or structure relating to joining.

98. An infant carrier comprising an infant carrier main body to be put on by a user and a horizontally-carrying seat to be suspended from the infant carrier main body for holding an infant in a horizontally-carrying state, wherein
an abdomen pad covering an abdomen of an infant is provided on a buttocks side of the horizontally-carrying seat, and a chest pad covering a chest of the infant is provided continuously at an upper end of the abdomen pad.
